(19) United States
(12) Patent Application Publication
(10) Pub. No.: US 2026/0029675 A1
(43) Pub. Date: Jan. 29, 2026

(54) LIQUID CRYSTAL DISPLAY DEVICE AND MANUFACTURING METHOD THEREOF

(71) Applicant: Century Technology (Shenzhen) Corp., LTD., Shen-zhen (CN)

(72) Inventors: LI WEN, Shen-zhen (CN); SHUI-MING GU, Shen-zhen (CN); FENG-HSIANG LIU, Shen-zhen (CN); WEN-CHIN LO, Shen-zhen (CN); CHUN-YUN PAN, Shen-zhen (CN); SIN-TUNG HUANG, Shen-zhen (CN); CHIEN-YU WEI, Shen-zhen (CN); TA-CHIEN CHEN, Shen-zhen (CN); CHIA-MING HSU, Shen-zhen (CN); CHEN-SHENG LEE, Shen-zhen (CN); HSIN-HUANG CHEN, Shen-zhen (CN); CHEN-FU MAI, Shen-zhen (CN); PING LIU, Shen-zhen (CN); JIE XIAO, Shen-zhen (CN); JUN-WEN LIU, Shen-zhen (CN); ZE-YUAN LI, Shen-zhen (CN); MENG-CHIEH TAI, Shen-zhen (CN)

(21) Appl. No.: 19/281,912

(22) Filed: Jul. 28, 2025

(30) Foreign Application Priority Data
Jul. 29, 2024 (CN) 202411032639.8
Jul. 31, 2024 (CN) 202411039469.6
Jul. 31, 2024 (CN) 202411051811.4
Aug. 9, 2024 (CN) 202411095077.1
Oct. 25, 2024 (CN) 202411499711.8
Oct. 31, 2024 (CN) 202411551935.9
Dec. 20, 2024 (CN) 202411907678.8

(51) Int. Cl. G02F 1/1335; F21V 8/00; G02F 1/1362; G02F 1/1368

(52) U.S. Cl. CPC G02F 1/133614; G02B 6/0033; G02F 1/133528; G02F 1/136222; G02F 1/1368

(57) ABSTRACT

A liquid crystal display device includes a backlight module, a quantum dot repairing film, a quantum dot layer, and a panel module. The backlight module has a light-emitting surface, which has a central area and a peripheral area surrounding the central area. The quantum dot repairing film is disposed on the peripheral area, and is malleable and adhesive. The quantum dot layer is disposed on the central area and the quantum dot repairing film. The panel module is disposed on the quantum dot layer, and includes a light-shielding layer. A projection of the light-shielding layer along a normal of the light-emitting surface partially overlaps a projection of the quantum dot repairing film along the normal of the light-emitting surface, and a projection of an inner edge of the light-shielding layer along the normal of the light-emitting surface is located in the projection of the quantum dot repairing film.

### CROSS-REFERENCE TO RELATED APPLICATION

This application claims priority to Chinese Patent Applications No. CN 202411551935.9 filed on 2024 Oct. 31; CN 202411907678.8 filed on 2024 Dec. 20; CN 202411032639.8 filed on 2024 Jul. 29; CN 202411051811.4 filed on 2024 Jul. 31; CN 202411039469.6 filed on 2024 Jul. 31; CN 202411095077.1 filed on 2024 Aug. 9; CN 202411499711.8 filed on 2024 Oct. 25, the disclosures of which are incorporated herein in their entirety by reference.

### TECHNICAL FIELD

The present disclosure relates to a liquid crystal display device and a manufacturing method thereof, especially to a liquid crystal display device with quantum dots and a manufacturing method thereof.

### BACKGROUND

With the advancement of technology, existing electronic products are generally equipped with display panels to have display functions, such as smartphones, tablet computers, notebook computers, wearable bracelets, and wearable watches. To meet the requirements of wide color gamut, light weight, thinness, and low energy consumption of display panels, existing display panels use quantum dot materials as a layer in the backlight module of the display panel (hereinafter referred to as the quantum dot layer). The quantum dot layer is used to receive the light emitted by the backlight unit in the backlight module to generate light of different colors.

However, affected by the moisture in the air, the quantum dot materials at the edge of the quantum dot layer are prone to failure due to contact with moisture, so that the light emitted around the backlight module (corresponding to the edge of the quantum dot layer) fails to effectively perform light-color conversion, resulting in a light-leakage defect of blue/violet light. In other words, there is a certain range of failure areas at the edge of the quantum dot layer, which causes the light-leakage phenomenon around the backlight module. Although existing display panels are generally provided with frames to shield the periphery of the backlight module, the failure areas at the edge of the quantum dot layer in the backlight module still cannot be completely shielded, therefore the existing liquid crystal display devices still have the problem of light leakage.

On the other hand, with the development of technology, printed circuit boards have become an indispensable part of different electronic products (such as but not limited to motherboards, light-emitting panels, and development boards). Common printed circuit boards include single-layer printed circuit boards (single-layer PCB), double-layer printed circuit boards (double-layer PCB), and multi-layer printed circuit boards (multi-layer PCB), and the structures of each printed circuit board are different.

For example, a single-layer printed circuit board only has one conductor layer as the conductive traces of the circuit, and electronic components can only be arranged on one surface of the single-layer printed circuit board. In contrast, double-layer printed circuit boards and multi-layer printed circuit boards have two conductor layers and multiple conductor layers respectively as the conductive traces of the circuit, and electronic components can be arranged on the front and back surfaces of the double-layer printed circuit boards and the front and back surfaces of the multi-layer printed circuit boards.

However, limited by the structure of the printed circuit board (PCB), the multiple conductive traces on the same conductor layer cannot cross each other. In other words, the multiple conductive traces on the same conductor layer must each form independent circuits to avoid short-circuits, which makes the circuit design more complex. Even though the electronic components on the front and back surfaces of double-layer PCBs and multi-layer PCBs can be electrically connected through multiple conductive layers, through holes, blind vias, and/or buried holes, there may still be a problem of short-circuits caused by the crossing of multiple conductive traces on the same conductor layer in double-layer PCBs and multi-layer PCBs.

On the other hand, the existing backlight board has a scanning circuit and a driving circuit. The scanning circuit can send scan signals to specified light emission points through each column of scan lines, and the driving circuit can send drive signals to the light emission points that receive the drive signals to light up the light-emitting elements of the light emission points. The current scanning circuit scans each column of scan lines in a preset scanning order, so that multiple light emission points on each column of scan lines can receive scan signals simultaneously. In order to ensure that the light emission points on the same column of scan lines all receive scan signals, the scanning circuit actuates multiple switches connected to the light emission points on the same column of scan lines simultaneously in one scanning sequence. However, when multiple switches are actuated simultaneously, each switch turns on and off instantaneously, and the voltage of each switch is instantaneously increased and then suddenly decreased. As a result, the power supply circuit that supplies power to the scanning circuit will produce a resonance phenomenon (for example, the resonant circuit of the power supply circuit resonates in response to the instantaneous voltage change). Here, the power supply circuit will generate low-frequency noise under the resonance phenomenon, and the continuous scanning of each scan line will further amplify the low-frequency noise.

On the other hand, the thin-film transistor liquid-crystal panel (TFT-LCD panel) is a common display panel and is often used in various types of displays. In the existing TFT-LCD panels, conductive gold balls are placed between a TFT-LCD substrate and a color filter substrate, so that the TFT-LCD substrate is electrically connected to the color filter substrate. However, since the material of the conductive gold balls is different from the materials of each layer in the TFT-LCD substrate, when forming the conductive gold balls on the TFT-LCD substrate, the instruments and materials of the manufacturing process need to be changed to perform the step of forming the conductive gold balls. Therefore, the manufacturing process of the TFT-LCD panel becomes complex and time-consuming.

On the other hand, the Liquid Crystal Display (LCD) is an important part of the existing display technologies and is widely used in the screens of electronic devices such as mobile phones, tablet computers, televisions, and computers. In the manufacturing process of LCDs, large-sized display panels are first synthesized, and then the panels are cut into sizes that meet the requirements of end products using panel cutting technology.

The panel cutting technology and its cutting effectiveness directly affect the yield, quality of end electronic devices, and the experience of end users. Generally speaking, an LCD consists of a thin film transistor (TFT), a color filter (CF), and liquid crystals. The liquid crystals are filled between the TFT and the CF, and a peripheral sealant is used to form an enclosed space between the TFT and the CF to seal the liquid crystals inside.

When cutting the display panel, a cutter wheel is used to cut the area coated with the peripheral sealant to prevent the liquid crystals from leaking out, and methods such as breaking or laser are used to break the cut area. However, even so, since both the TFT and the CF are made of thin glass materials, the panel is still prone to cracking or generating cracks during cutting or breaking, which affects the quality of the LCD.

In the past, methods such as using jigs for breaking, adjusting the number of teeth, angle, tooth depth of the cutter wheel, the cutting parameters of the cutter wheel, or the thickness of the cutting liner paper were often used to reduce the damage caused during cutting and breaking.

On the other hand, with the rapid development of display technology, the market demand for high-quality display effects is becoming stronger and stronger. Early display technologies mainly focused on improving resolution and color performance. However, with the continuous advancement of technology, users' requirements for displays are no longer limited to basic picture display quality. They also need the display to provide stable and consistent picture quality in different usage scenarios.

On the other hand, in the existing display devices, the LED panel adopts a 2S1P (2 Series 1 Parallel) circuit architecture. In other words, at any time point when the LED panel is operating (i.e., the LED panel scans all the light emitting diodes within a cycle), two light emitting diodes connected in series in the LED panel will emit light simultaneously. However, limited by the 2S1P circuit architecture, when the picture displayed by the existing display device contains graphics or text with edges, the LED panel may cause additional light emitting diodes to emit light, resulting in a halo (corresponding to the additionally emitting light emitting diodes) on the picture displayed by the display device, which in turn affects the quality of the display device.

### SUMMARY

In view of this, the inventor proposes a liquid crystal display device, which includes: a backlight module, a quantum dot repairing film, a quantum dot layer, and a panel module. The backlight module has a light-emitting surface, and the light-emitting surface has a central area and a peripheral area surrounding the central area; the quantum dot repairing film is disposed on the peripheral area; the quantum dot layer is disposed on the central area and the quantum dot repairing film; and the panel module is disposed on the quantum dot layer. The panel module includes a light-shielding layer, wherein the projection of the light-shielding layer along the normal of the light-emitting surface partially overlaps with the projection of the quantum dot repairing film along the normal of the light-emitting surface, and the projection of the inner edge of the light-shielding layer along the normal of the light-emitting surface is located within the projection of the quantum dot repairing film along the normal of the light-emitting surface.

In some embodiments, the backlight module includes: a substrate layer, which includes a plurality of sidewalls and a base plate, wherein the plurality of sidewalls are disposed around the base plate; a reflective layer, which is disposed on the base plate; a light guide layer, which is disposed on the reflective layer; and an edge-lit backlight unit, which is disposed on the wall surface of at least one of the plurality of sidewalls.

In some embodiments, the light-shielding layer is disposed on the quantum dot layer and the substrate layer through an adhesive.

In some embodiments, the quantum dot repairing film is further disposed on the wall surface of each of the remaining sidewalls.

In some embodiments, the backlight module includes: a substrate layer, which includes a plurality of sidewalls and a base plate, wherein the plurality of sidewalls are disposed around the base plate; a reflective layer, which is disposed on the base plate; a light guide layer, which is disposed on the reflective layer; and a direct-lit backlight unit, which is disposed between the reflective layer and the light guide layer.

In some embodiments, the light-shielding layer is disposed on the quantum dot layer and the substrate layer through an adhesive.

In some embodiments, the quantum dot repairing film is further disposed on the wall surfaces of each of the sidewalls.

In some embodiments, the panel module includes: a first polarization layer; a thin film transistor layer, which is disposed on the first polarization layer; a color filter layer, which is disposed on the thin film transistor layer; and a second polarization layer, which is disposed on the color filter layer; wherein the sum of the thickness of the first polarization layer, the thickness of the thin film transistor layer, the thickness of the color filter layer, and the thickness of the second polarization layer is equal to the thickness of the light-shielding layer, and the light-shielding layer surrounds the first polarization layer, the thin film transistor layer, the color filter layer, and the second polarization layer.

In some embodiments, the material of the light-shielding layer is a black matrix material.

In some embodiments, the liquid crystal display device further includes an optical film layer, wherein the optical film layer is disposed between the quantum dot layer and the panel module.

The inventor also proposes a manufacturing method of a liquid crystal display device, including: providing a backlight module, the backlight module having a light-emitting surface, the light-emitting surface having a central area and a peripheral area surrounding the central area; disposing a quantum dot repairing film on the peripheral area; disposing a quantum dot layer on the central area and the quantum dot repairing film; disposing a panel module on the quantum dot layer; and disposing a light-shielding layer on the panel module, wherein the projection of the light-shielding layer along the normal of the light-emitting surface partially overlaps with the projection of the quantum dot repairing film along the normal of the light-emitting surface, and the projection of the inner edge of the light-shielding layer along the normal of the light-emitting surface is located within the projection of the quantum dot repairing film along the normal of the light-emitting surface.

In some embodiments, the manufacturing method of a liquid crystal display device includes: providing a backlight module, the backlight module having a light-emitting surface, wherein the light-emitting surface has a central area and a peripheral area surrounding the central area; disposing a quantum dot repairing film on the peripheral area; disposing a quantum dot layer on the central area and the quantum dot repairing film; forming a thin-film transistor substrate, wherein the thin-film transistor substrate includes a plurality of electrode layers; forming a metal post, wherein the metal post extends from one of the plurality of electrode layers along the normal direction of the surface of the thin-film transistor substrate to be exposed on the surface of the thin-film transistor substrate, and the material of the metal post is the same as that of one of the plurality of electrode layers; disposing a liquid crystal material on the thin-film transistor substrate to form a liquid crystal layer, wherein the liquid crystal layer is adjacent to the metal post; disposing a color filter substrate on the liquid crystal layer and the metal post, wherein the color filter substrate is electrically connected to the thin-film transistor substrate through the metal post to form a panel module; disposing the panel module on the quantum dot layer; and disposing a light-shielding layer on the panel module, wherein the projection of the light-shielding layer along the normal of the light-emitting surface partially overlaps with the projection of the quantum dot repairing film along the normal of the light-emitting surface, and the projection of the inner edge of the light-shielding layer along the normal of the light-emitting surface is located within the projection of the quantum dot repairing film along the normal of the light-emitting surface.

In some embodiments, the plurality of electrode layers include a gate layer, a drain layer, and a source layer. The steps of forming the thin-film transistor substrate include: forming the gate layer on a glass layer; forming a first insulating layer on the glass layer to cover the gate layer; forming a channel layer on the first insulating layer; respectively forming the drain layer and the source layer on two sides of the channel layer, wherein there is an interval between the drain layer and the source layer; and forming a second insulating layer on the source layer, the drain layer, and the channel layer in the interval. The step of forming the metal post is synchronized with the step of forming the gate layer, the drain layer, or the source layer.

In some embodiments, the metal post is a cylinder or a truncated cone. The bottom surface of the metal post is coupled to the surface of one of the plurality of electrode layers, and the top surface of the metal post is coupled to the color filter substrate.

The inventor also proposes a light-emitting diode (LED) circuit, which includes: a circuit board, a plurality of first light-emitting units, a first terminal set, a first conductive trace, a plurality of second light-emitting units, a second terminal set, a second conductive trace, and at least one resistor. The circuit board includes a first surface; the plurality of first light-emitting units are disposed on the first surface; the first terminal set is disposed on the first surface; the first conductive trace is disposed on the first surface to electrically connect the plurality of first light-emitting units and the first terminal set together; the plurality of second light-emitting units are disposed on the first surface; the second terminal set is disposed on the first surface; the second conductive trace is disposed on the first surface to electrically connect the plurality of second light-emitting units and the second terminal set together; and at least one resistor is disposed on the first conductive trace and/or the second conductive trace to serve as a jumper for any section of the first conductive trace and/or a jumper for any section of the second conductive trace.

In some embodiments, the circuit board includes a first section and a second section vertically connected to the first section. The first section is longer than the second section. The plurality of first light-emitting units and the plurality of second light-emitting units are located in the first section, and the first terminal set and the second terminal set are located in the second section.

In some embodiments, the first terminal set includes a first positive electrode and a first negative electrode, and the first positive electrode and the first negative electrode are respectively disposed at two ends of the first conductive trace.

In some embodiments, the second terminal set includes a second positive electrode and a second negative electrode, and the second positive electrode and the second negative electrode are respectively disposed at two ends of the second conductive trace.

In some embodiments, the plurality of first light-emitting units and the plurality of second light-emitting units are arranged in a staggered manner to form an array.

In some embodiments, the at least one resistor is further used to replace any section of the first conductive trace, and the at least one resistor is further used to adjust the resistance value of the first conductive trace.

In some embodiments, the at least one resistor is further used to replace any section of the second conductive trace, and the at least one resistor is further used to adjust the resi stance value of the second conductive trace.

In some embodiments, the circuit board is a single-layer printed circuit board.

The inventor also proposes a circuit board structure, including: a circuit board, a plurality of electronic components, a plurality of conductive traces, and at least one resistor. The circuit board includes a first surface; the plurality of electronic components are disposed on the first surface; the plurality of conductive traces are disposed on the first surface, and each of the conductive traces is used to electrically connect at least two of the plurality of electronic components together; and at least one resistor is disposed on at least one of the plurality of conductive traces and used as a jumper for any section of at least one of the plurality of conductive traces.

The inventor also proposes a light emitting diode (LED) backlight panel, including: a circuit board, a plurality of drive lines, and a plurality of scan lines. The circuit board has an operable area; the plurality of drive lines are located on the circuit board and are sequentially arranged on the operable area in a first arrangement direction; and the plurality of scan lines are located on the circuit board and define a plurality of light emission points in a matrix configuration with the drive lines on the operable area. The relative positions of the plurality of light emission points formed by the same scan line and the drive lines among the light emission points are staggered from each other in a second arrangement direction, and the first arrangement direction is different from the second arrangement direction.

In some embodiments, the LED backlight panel further includes a scanning circuit located on the circuit board and coupled to the scan lines for sending scan signals to the scan lines. In each scanning sequence, the scanning circuit sends the scan signal to one of the scan lines, and the arrangement order of the plurality of light emission points that receive the scan signal among the light emission points on the drive lines is staggered from each other.

In some embodiments, the LED backlight panel further includes a driving circuit coupled to the drive lines for sending drive signals to the drive lines.

In some embodiments, the LED backlight panel further includes a plurality of light emitting diodes respectively coupled between the drive lines and the scan lines that define the light emission points and used to emit light according to the drive signals.

In some embodiments, the driving circuit includes a drive signal generation module having a plurality of transmission channels and used to generate the drive signals and output them to the transmission channels.

In some embodiments, the number of the transmission channels is a multiple of the number of the scan lines.

In some embodiments, the scanning circuit further includes a plurality of scan switches. The scan switches are turned on in response to the scan signals to send the scan signals.

In some embodiments, these drive lines include a first drive line, a second drive line, a third drive line, and a fourth drive line. These scan lines include a first scan line, a second scan line, a third scan line, and a fourth scan line.

In some embodiments, these light emission points are divided into multiple first light emission points, multiple second light emission points, multiple third light emission points, and multiple fourth light emission points according to the scanning sequence. Among them, the intersections of the first scan line with the first drive line, the second drive line, the third drive line, and the fourth drive line are these first light emission points; the intersections of the second scan line with the first drive line, the second drive line, the third drive line, and the fourth drive line are these second light emission points; the intersections of the third scan line with the first drive line, the second drive line, the third drive line, and the fourth drive line are these third light emission points; and the intersections of the fourth scan line with the first drive line, the second drive line, the third drive line, and the fourth drive line are these fourth light emission points.

In some embodiments, during the first scanning sequence, these first light emission points obtain the scan signal; during the second scanning sequence, these second light emission points obtain the scan signal; during the third scanning sequence, these third light emission points obtain the scan signal; during the fourth scanning sequence, these fourth light emission points obtain the scan signal.

The inventor also proposes a TFT-LCD panel unit, which includes: a thin-film transistor substrate, a liquid crystal layer, a metal post, and a color filter substrate. The thin-film transistor substrate includes a plurality of electrode layers; the liquid crystal layer is disposed on the surface of the thin-film transistor substrate; the metal post extends from one of the plurality of electrode layers along the normal direction of the surface of the thin-film transistor substrate to be exposed on the surface of the thin-film transistor substrate, and the metal post is adjacent to the liquid crystal layer; and the color filter substrate is disposed on the liquid crystal layer and the metal post and is electrically connected to the thin-film transistor substrate through the metal post. Among them, the material of the metal post is the same as that of one of the plurality of electrode layers.

In some embodiments, the plurality of electrode layers include a gate layer, a drain layer, and a source layer, and the thin-film transistor substrate further includes: a glass layer, wherein the gate layer is disposed on the glass layer; a first insulating layer, disposed on the glass layer to cover the gate layer; a channel layer, disposed on the first insulating layer, wherein the drain layer and the source layer are respectively disposed on two sides of the channel layer and are spaced apart by an interval; and a second insulating layer, disposed on the drain layer, the source layer, and the channel layer in the interval.

In some embodiments, the metal post is a cylinder. The bottom surface of the metal post is coupled to the surface of one of the plurality of electrode layers, and the top surface of the metal post is coupled to the color filter substrate.

In some embodiments, the metal post further includes at least one metal truncated cone. The bottom surface of the at least one metal truncated cone is coupled to the top surface of the metal post, and the top surface of the at least one metal truncated cone is coupled to the color filter substrate.

In some embodiments, the metal post is a truncated cone. The bottom surface of the metal post is coupled to the surface of one of the plurality of electrode layers, and the top surface of the metal post is coupled to the color filter substrate.

The inventor also proposes a manufacturing method for a TFT-LCD panel unit, which includes: forming a thin-film transistor substrate, wherein the thin-film transistor substrate includes a plurality of electrode layers; forming a metal post, wherein the metal post extends from one of the plurality of electrode layers along the normal direction of the surface of the thin-film transistor substrate to be exposed on the surface of the thin-film transistor substrate; disposing a liquid crystal material on the thin-film transistor substrate to form a liquid crystal layer, wherein the liquid crystal layer is adjacent to the metal post; and disposing a color filter substrate on the liquid crystal layer and the metal post, wherein the color filter substrate is electrically connected to the thin-film transistor substrate through the metal post; wherein, the material of the metal post is the same as the material of one of the plurality of electrode layers.

In some embodiments, the plurality of electrode layers include a gate layer, a drain layer, and a source layer, and the step of forming the thin-film transistor substrate includes: forming the gate layer on a glass layer; forming a first insulating layer on the glass layer to cover the gate layer; forming a channel layer on the first insulating layer; respectively forming the drain layer and the source layer on two sides of the channel layer, wherein there is an interval between the drain layer and the source layer; and forming a second insulating layer on the source layer, the drain layer, and the channel layer in the interval; wherein, the step of forming the metal post is synchronized with the step of forming the gate layer, the step of forming the drain layer, or the step of forming the source layer.

In some embodiments, the metal post is a cylinder. The bottom surface of the metal post is coupled to the surface of one of the plurality of electrode layers, and the top surface of the metal post is coupled to the color filter substrate.

In some embodiments, the metal post further includes at least one metal truncated cone. The bottom surface of the at least one metal truncated cone is coupled to the top surface of the metal post, and the top surface of the at least one metal truncated cone is coupled to the color filter substrate.

In some embodiments, the metal post is a truncated cone. The bottom surface of the metal post is coupled to the surface of one of the plurality of electrode layers, and the top surface of the metal post is coupled to the color filter substrate.

The inventor also proposes a panel manufacturing method, including: cutting a first substrate to form a first cutting line, wherein the first substrate includes a display area and a terminal area, the first end of the terminal area is connected to the display area, and the first cutting line is located at the second end of the terminal area; cutting the first substrate to form a second cutting line, with a first excess material between the second cutting line and the first cutting line; cutting a second substrate to form a third cutting line, wherein the second substrate is connected to the display area of the first substrate, and the third cutting line corresponds to the first end of the terminal area; cutting the second substrate to form a fourth cutting line, with a second excess material between the fourth cutting line and the third cutting line, and the fourth cutting line corresponding to the second cutting line; and cutting the second excess material to form a fifth cutting line, wherein the fifth cutting line corresponds to the first cutting line so that the first substrate and the second substrate break at the first cutting line, the second cutting line, the third cutting line, and the fourth cutting line.

In some embodiments, the first substrate includes a plurality of first sub-substrates adjacent to each other, and each of the first sub-substrates includes the display area and the terminal area.

In some embodiments, the number of the first excess materials is plural, and each has a first side and a second side opposite to each other. The first sub-substrate is connected to the first side of the first excess material with the second end of the terminal area, and is connected to the second side of the first excess material with the display area of another adjacent first sub-substrate.

In some embodiments, the second substrate includes a plurality of second sub-substrates adjacent to each other. The number of the second excess materials is plural, and each has a third side and a fourth side opposite to each other. The second sub-substrate is connected to the third side of the second excess material, and another adjacent second sub-substrate is connected to the fourth side of the second excess material.

In some embodiments, the first cutting line, the second cutting line, the third cutting line, the fourth cutting line, and the fifth cutting line are respectively formed by a cutting wheel.

In some embodiments, the second substrate and the display area of the first substrate are connected by glue.

In some embodiments, after breaking at the first cutting line, the second cutting line, the third cutting line, and the fourth cutting line, the first excess material and the second excess material are separated from the first substrate and the second substrate to expose the terminal area.

In some embodiments, the first substrate is a thin-film transistor substrate.

In some embodiments, the second substrate is a color filter.

In some embodiments, the terminal area can be used for electrically connecting signal lines.

The inventor also proposes an image processing method, including: outputting a display screen with a display module; detecting a type of the display screen; selecting a corresponding driving parameter set according to the type; and adjusting the display screen according to the driving parameter set.

In some embodiments, the type of the display screen includes a first type, and the driving parameter set includes a first parameter set corresponding to the first type. When the type of the display screen is the first type, the first parameter set is selected and the display screen is adjusted according to the first parameter set.

In some embodiments, the type of the display screen includes a second type, and the driving parameter set includes a second parameter set corresponding to the second type. The first type is different from the second type, and the first parameter set is different from the second parameter set. When the type of the display screen is the second type, the second parameter set is selected and the display screen adjusted according to the second parameter set.

In some embodiments, the first type is a normal display screen, and the second type is a special screen. The special screen includes a flicker test screen, a heavy-load screen, or a dynamic test screen.

In some embodiments, the driving parameter set includes charging time, charging speed, display time, pixel inversion mode, page-update frequency, gate voltage, or pixel voltage.

In some embodiments, detecting the type of the display screen includes: detecting a screen feature of the display screen output by the display module; and analyzing the type of the display screen according to the screen feature.

In some embodiments, the screen feature is a touch feature value, and the touch feature value includes noise and capacitance change.

In some embodiments, the screen feature is screen data, including brightness distribution, contrast, or color composition.

In some embodiments, the image processing method further includes performing pixel inversion on the display screen; and adjusting the driving parameter set to compensate for the brightness of the display screen.

The inventor also proposes an image processing panel, including: a display module and a drive module. The display module includes a display and a display circuit. The display circuit is electrically connected to the display to control the display to output a display screen; the drive module is electrically connected to the display circuit and includes: a computing module and a driving circuit. The computing module is used to detect a type of the display screen; and the driving circuit is electrically connected to the computing module. The driving circuit includes a plurality of driving parameter sets. The driving circuit selects the corresponding driving parameter set according to the type of the display screen and drives the display circuit to adjust the display screen according to the driving parameter set.

The inventor also proposes an LED array, which includes: a first light emitting diode and a plurality of second light emitting diodes. The plurality of second light emitting diodes are connected in parallel to the first light emitting diode; wherein, in response to the first light emitting diode being grounded and one of the second light emitting diodes receiving a modulation signal, the first light emitting diode and the second light emitting diode receiving the modulation signal emit light.

In some embodiments, the LED array further includes: a control element, electrically connected to the first light emitting diode, for controlling the first light emitting diode to be open-circuited or grounded; and a modulation signal generation element, electrically connected to the plurality of second light emitting diodes, for generating the modulation signal to be provided to each of the second light emitting diodes.

In some embodiments, the LED array further includes: a control element, electrically connected to the first light emitting diode, for controlling the first light emitting diode to be open-circuited or grounded; and a plurality of modulation signal generation elements, each of which is electrically connected to each of the second light emitting diodes, and each of the modulation signal generation elements is used to generate the modulation signal to be provided to each of the second light emitting diodes.

In some embodiments, the LED array further includes: a circuit board, on which the first light emitting diode and the plurality of second light emitting diodes are arranged; wherein, the plurality of second light emitting diodes are four second light emitting diodes, and each of the second light emitting diodes is individually adjacent to a first side of the first light emitting diode, a second side of the first light emitting diode, a third side of the first light emitting diode, and a fourth side of the first light emitting diode.

In some embodiments, the direction of the first side of the first light emitting diode corresponds to the positive X direction in the Cartesian coordinate system, the direction of the second side of the first light emitting diode corresponds to the positive Y direction in the Cartesian coordinate system, the direction of the third side of the first light emitting diode corresponds to the negative X direction in the Cartesian coordinate system, and the direction of the fourth side of the first light emitting diode corresponds to the negative Y direction in the Cartesian coordinate system.

The inventor also proposed an LED panel, which includes a plurality of LED arrays, wherein each of the LED arrays includes: a first light emitting diode and a plurality of second light emitting diodes. The plurality of second light emitting diodes are connected in parallel to the first light emitting diode; wherein, in response to the first light emitting diode being grounded and one of the second light emitting diodes receiving a modulation signal, the first light emitting diode and the second light emitting diode receiving the modulation signal emit light; two adjacent LED arrays share at least one of the plurality of second light emitting diodes.

In some embodiments, each LED array further includes: a control element electrically connected to the first light emitting diode for controlling the first light emitting diode to be open-circuited or grounded; and a modulation signal generation element electrically connected to the plurality of second light emitting diodes for generating the modulation signal to be provided to each of the second light emitting diodes.

In some embodiments, each LED array further includes: a control element electrically connected to the first light emitting diode for controlling the first light emitting diode to be open-circuited or grounded; and a plurality of modulation signal generation elements, each of which is electrically connected to each of the second light emitting diodes, and each of the modulation signal generation elements is used to generate the modulation signal to be provided to each of the second light emitting diodes.

In some embodiments, the LED panel further includes: a circuit board; wherein, the plurality of second light emitting diodes are four second light emitting diodes, the first light emitting diode and the four second light emitting diodes are disposed on the circuit board, and each of the second light emitting diodes is individually adjacent to a first side of the first light emitting diode, a second side of the first light emitting diode, a third side of the first light emitting diode, and a fourth side of the first light emitting diode.

In some embodiments, the direction of the first side corresponds to the positive X direction in the Cartesian coordinate system, the direction of the second side corresponds to the positive Y direction in the Cartesian coordinate system, the direction of the third side corresponds to the negative X direction in the Cartesian coordinate system, and the direction of the fourth side corresponds to the negative Y direction in the Cartesian coordinate system.

### BRIEF DESCRIPTION OF DRAWINGS

FIG. 1 is a top plan view of a liquid crystal display device according to an embodiment of the present disclosure.

FIG. 2 is a schematic cross-sectional view of the liquid crystal display device in FIG. 1 of the present disclosure taken along section line 2-2.

FIG. 3 is a top plan view of an embodiment of the backlight module in FIG. 2 of the present disclosure.

FIG. 4 is a schematic cross-sectional view of a first embodiment of the liquid crystal display device in FIG. 2 of the present disclosure.

FIG. 5 is a schematic cross-sectional view of a second embodiment of the liquid crystal display device in FIG. 2 of the present disclosure.

FIG. 6 is a schematic cross-sectional view of a third embodiment of the liquid crystal display device in FIG. 2 according to the present disclosure.

FIG. 7 is a schematic cross-sectional view of a fourth embodiment of the liquid crystal display device in FIG. 2 according to the present disclosure.

FIG. 8 is a schematic cross-sectional view of a fifth embodiment of the liquid crystal display device in FIG. 2 according to the present disclosure.

FIG. 9 is a schematic cross-sectional view of a sixth embodiment of the liquid crystal display device in FIG. 2 according to the present disclosure.

FIG. 10 is a schematic diagram of a circuit board structure according to a seventh embodiment of the present disclosure.

FIG. 11 is a schematic diagram of a circuit board structure according to an eighth embodiment of the present disclosure.

FIG. 12 is a schematic diagram of a circuit board structure according to a ninth embodiment of the present disclosure.

FIG. 13 is a schematic diagram of a light emitting diode circuit according to a tenth embodiment of the present disclosure.

FIG. 14 is a schematic diagram of a light emitting diode circuit according to an eleventh embodiment of the present disclosure.

FIG. 15 is a schematic diagram of a light emitting diode circuit according to a twelfth embodiment of the present disclosure.

FIG. 16 is a schematic diagram of a light emitting diode circuit according to a thirteenth embodiment of the present disclosure.

FIG. 17 is a functional block diagram of a light emitting diode backlight panel according to some embodiments of the present disclosure.

FIG. 18 is a schematic implementation diagram of a light emitting diode backlight panel according to some embodiments of the present disclosure.

FIG. 19A is a schematic operation diagram of the light emitting diode backlight panel in FIG. 18 according to the present disclosure during the first scanning sequence.

FIG. 19B is a schematic operation diagram of the light emitting diode backlight panel in FIG. 18 according to the present disclosure during the second scanning sequence.

FIG. 19C is a schematic operation diagram of the light emitting diode backlight panel in FIG. 18 according to the present disclosure during the third scanning sequence.

FIG. 19D is a schematic diagram illustrating the operation of the LED backlight panel of FIG. 18 according to the present disclosure in the fourth scanning sequence.

FIG. 20 is a side plan view of a TFT-LCD panel unit according to a fourteenth embodiment of the present disclosure.

FIG. 21 is a side plan view of a TFT-LCD panel unit according to a fifteenth embodiment of the present disclosure.

FIG. 22 is an operation flowchart of a manufacturing method of a TFT-LCD panel unit according to some embodiments of the present disclosure.

FIG. 23 is a side plan view of an embodiment of a thin-film transistor substrate according to some embodiments of the present disclosure.

FIG. 24 is an operation flowchart of a manufacturing method of a thin-film transistor substrate according to some embodiments of the present disclosure.

FIG. 25 is a schematic side view of a TFT-LCD panel unit according to a sixteenth embodiment of the present disclosure.

FIG. 26 is a schematic side view of a TFT-LCD panel unit according to a seventeenth embodiment of the present disclosure.

FIG. 27 is a schematic diagram of a panel according to some embodiments of the present disclosure.

FIG. 28 is a schematic diagram of the positions of each cutting line according to some embodiments of the present disclosure.

FIG. 29 is a microscopic image of feather cracks on the cutting section of the terminal area according to some embodiments of the present disclosure.

FIG. 30 is an electron microscopic image of feather cracks on the cutting section of the terminal area according to some embodiments of the present disclosure.

FIG. 31 is a functional block diagram of an image processing panel according to some embodiments of the present disclosure.

FIG. 32 is a flowchart of an image processing method according to some embodiments of the present disclosure.

FIG. 33 is a flowchart of detecting the type of display screen according to some embodiments of the present disclosure.

FIG. 34 is a schematic waveform diagram of a gate voltage signal according to some embodiments of the present disclosure.

FIG. 35 is a schematic waveform diagram of the charging speed according to some embodiments of the present disclosure.

FIG. 36 is a schematic circuit diagram of a light emitting diode (LED) array according to an embodiment of the present disclosure.

FIG. 37 is a schematic circuit diagram of an LED array according to another embodiment of the present disclosure.

FIG. 38 is a schematic top view of an LED array according to an embodiment of the present disclosure.

FIG. 39 is a schematic circuit diagram of the LED array in FIG. 38 according to the present disclosure.

FIG. 40 is a schematic top view of an embodiment of the LED array in FIG. 38 according to the present disclosure.

FIG. 41 is a schematic circuit diagram of a light emitting diode (LED) panel according to an embodiment of the present disclosure.

FIG. 42 is a schematic circuit diagram of an LED panel according to another embodiment of the present disclosure.

FIG. 43 is a schematic top view of an LED panel according to an embodiment of the present disclosure.

FIG. 44 is a schematic top view of an LED panel according to another embodiment of the present disclosure.

FIG. 45 is a schematic top view of an embodiment of the LED panel in FIG. 43 according to the present disclosure.

### DESCRIPTION OF EMBODIMENTS

In order to make the purposes, means, and effects of the technical means disclosed in different embodiments of the present disclosure more understandable, the following description will elaborate on specific embodiments of the proposed technical means in combination with the drawings. The descriptions of the technical means recorded in the following embodiments of the present disclosure are merely for illustration and example, and do not represent all the embodiments of the present disclosure, nor limit the present disclosure to specific embodiments. Based on the different embodiments in the present disclosure, all other embodiments obtained by those with ordinary knowledge in the technical field without excessive experimentation should fall within the scope of protection of the present disclosure.

It should be noted that when an element is referred to as being “disposed on” another element, it can be directly on the other element, or there may be elements existing between the two. When an element is considered to be “connected” to another element, it can be directly connected to the other element or there may be elements existing between the two at the same time. The terms “vertical”, “horizontal”, “left”, “right”, “upper”, “lower”, “inner”, “outer”, “front”, “rear” and similar expressions used in the present disclosure are only used to indicate the relative positional relationship based on the drawings, and do not limit that the elements using these terms can only be implemented in the indicated manner. When the absolute position of the described object changes, the description of the relative position may also change accordingly.

The term “comprising” used in the present disclosure is an open-ended term, so it should be interpreted as “including but not limited to”; the term “disposed on” means that two or more elements are in “direct” physical or electrical contact with each other, or in “indirect” physical or electrical contact with each other; and terms such as “a”, “another”, “first”, “second”, and “third” are used to distinguish the referred elements. Unless otherwise specified, they are not used to sort or limit the differences of the referred elements, nor to limit the scope of this case.

In this disclosure, descriptions such as “substantially”, “approximately”, and “about” are used to indicate the error ranges implied by possible unexpected impacts and deviations in the manufacturing process or material selection. The said error range can include the variation range that does not significantly change the material structure, configuration, characteristics, and effects, for example, a deviation range of 0%-10%. The said error range is clear to those with ordinary knowledge in this technical field. For example, when it is described that “two objects are substantially parallel”, in fact, if it is observed that there is a slight height difference between the two objects, but this difference is negligible relative to the size of the objects themselves (for example, less than 10%) and does not affect the effect, the relative configuration between the two observed objects will still be interpreted as being within the range of “substantially parallel” described in this disclosure.

In all descriptions related to specific numerical values in this disclosure, although not directly described, they all contain the meaning of “about” or “substantially”. That is, these specific numerical values will cover the possible numerical error ranges to indicate the possible unexpected impacts and deviations in the manufacturing process or material selection. The said numerical error range can include numerical changes that do not significantly change the material structure, characteristics, and effects, for example, a deviation range of 0%-10%. This error range is clear to those with ordinary knowledge in this technical field.

Unless otherwise defined, all technical and specific terms used in this disclosure have the same meanings as commonly understood by those with ordinary knowledge in the technical field to which this disclosure belongs. The terms used in this disclosure are only for the purpose of describing specific implementation modes and are not intended to limit this disclosure. The term “and/or” used in this disclosure includes any and all combinations of one or more of the relevant listed items.

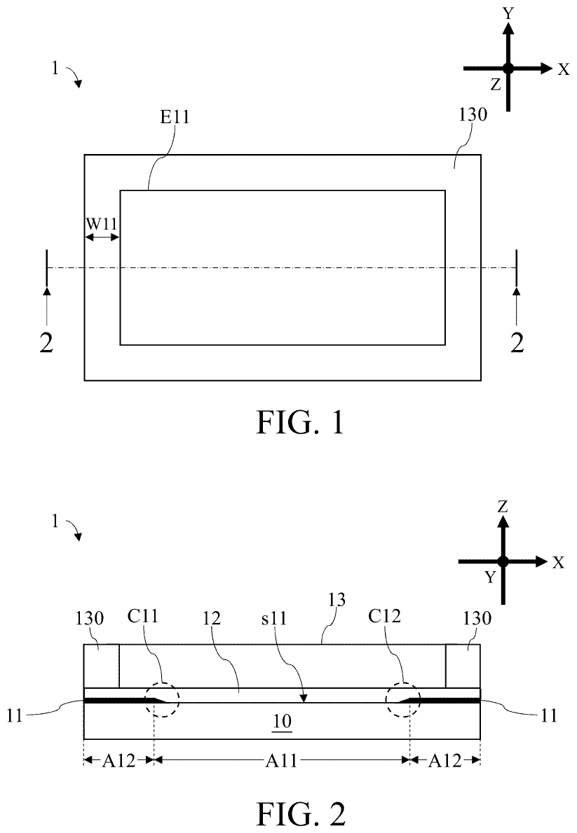

Please refer to FIG. 1 and FIG. 2. FIG. 1 is a top-plan view of a liquid crystal display (LCD) device 1 according to an embodiment of this disclosure, and FIG. 2 is a schematic cross-sectional view of the liquid crystal display device 1 in FIG. 1 along the section line 2-2 according to this disclosure. A liquid crystal display device 1 includes a backlight module 10, a quantum dot repairing film 11, a quantum dot layer 12, and a panel module 13. The backlight module 10 has a light-emitting surface s11, and the light-emitting surface s11 has a central area A11l and a peripheral area A12 surrounding the central area A11. The quantum dot repairing film 11 is disposed in the peripheral area A12.

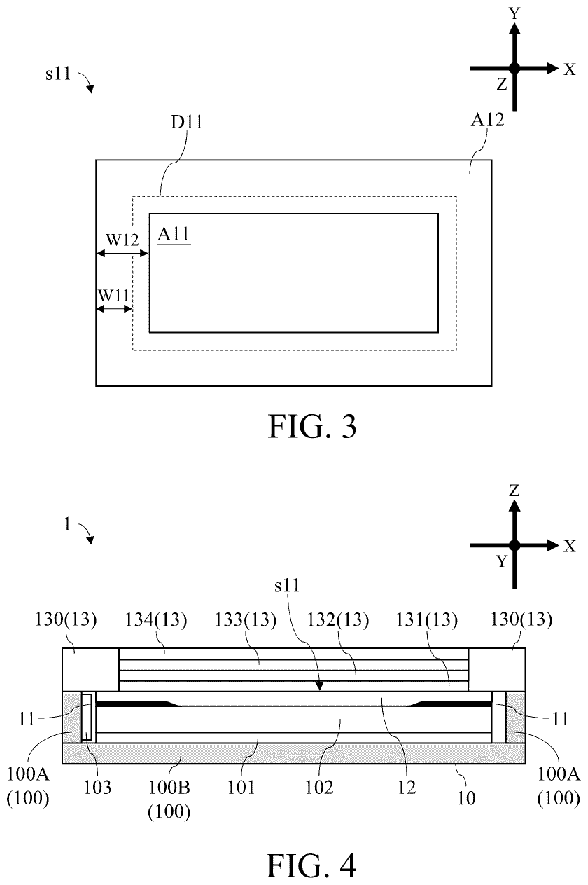

Please further refer to FIG. 3. FIG. 3 is a top-plan view of an embodiment of the backlight module 10 in FIG. 2 according to the present disclosure. Taking FIG. 3 as an example, in some embodiments, the quantum dot repairing film 11 is arranged around the backlight module 10 in a “square” shape (width W12). The quantum dot layer 12 is arranged in the central area A11 of the light-emitting surface s11 of the backlight module 10 and on the quantum dot repairing film 11. In other words, in some embodiments, the quantum dot layer 12 covers the quantum dot repairing film 11 and is arranged on the backlight module 10. In some embodiments, the quantum dot repairing film 11 has ductility. Here, when the quantum dot layer 12 is arranged on the quantum dot repairing film 11, the quantum dot repairing film 11 can fill the gap between the quantum dot layer 12 and the backlight module 10 (as shown by the dotted circular frame C11, C12 in FIG. 2). In addition, in some embodiments, the quantum dot repairing film 11 has adhesiveness. Here, the quantum dot repairing film 11 can be arranged on the peripheral area A12 of the light-emitting surface s11 of the backlight module 10 in the form of tape or double-sided tape, so that the quantum dot layer 12 is stably arranged on the backlight module 10 and the quantum dot repairing film 11.

The panel module 13 is arranged on the quantum dot layer 12, and the panel module 13 includes a light-shielding layer 130. Taking FIG. 1 as an example, in some embodiments, the light-shielding layer 130 is arranged around the panel module 13 in a “square” shape (width W11). In addition, a projection of the light-shielding layer 130 along a normal of the light-emitting surface s11 (corresponding to the Z-direction) partially overlaps with a projection of the quantum dot repairing film 11 along the normal of the light-emitting surface s11, and a projection of an inner edge E11 of the light-shielding layer 130 along the normal of the light-emitting surface s11 is located in a projection of the peripheral area A12 along the normal of the light-emitting surface s11. Taking FIG. 1 and FIG. 3 as an example, in some embodiments, the width W11 of the light-shielding layer 130 shown in FIG. 1 is smaller than the width W12 of the quantum dot repairing film 11 shown in FIG. 3. It should be noted that the dotted line D11 shown in FIG. 3 corresponds to the inner edge E11 of the light-shielding layer 130 shown in FIG. 1. Therefore, when the panel module 13 is arranged on the quantum dot layer 12, the light-shielding layer 130 cannot completely cover the quantum dot repairing film 11.

In some embodiments, the backlight module 10 is used to project light onto the panel module 13, and the panel module 13 is used to receive the light from the backlight module 10 to display images. Here, the liquid crystal display device 1 can be installed on any type of electronic device, enabling the electronic device to have the function of displaying images.

In some embodiments, the quantum dot repairing film 11 is used to enable the backlight module 10 to emit light with normal colors. Since the quantum dot materials at the edge of the quantum dot layer 12 may be affected by moisture in the air and become ineffective, the light emitted from the periphery of the light-emitting surface s11 of the backlight module 10 (roughly corresponding to the peripheral area A12 of the light-emitting surface s11 of the backlight module 10) is not effectively subjected to light color conversion, which in turn causes the phenomenon of light leakage around the light-emitting surface s11 of the backlight module 10. Therefore, in some embodiments, the quantum dot repairing film 11 is used to repair the light emitted from the periphery of the light-emitting surface s11 of the backlight module 10.

Specifically, when the backlight unit in the backlight module 10 emits light, the light incident on the peripheral area A12 of the light-emitting surface s11 of the backlight module 10 first penetrates the quantum dot repairing film 11 for light color conversion, and then penetrates the edge of the quantum dot layer 12 and enters the panel module 13. In other words, even if the quantum dot materials at the edge of the quantum dot layer 12 have been affected by moisture in the air and become ineffective, the ineffective quantum dot materials will not affect the light that has already completed the light color conversion. It should be noted that since the quantum dot materials in the central area of the quantum dot layer 12 (roughly corresponding to the central area A11 of the light-emitting surface s11 of the backlight module 10) are not affected by moisture in the air, the light penetrating through the central area of the quantum dot layer 12 can still undergo light color conversion. Here, all areas (including the central area A11 and the peripheral area A12) in the light-emitting surface s11 of the backlight module 10 can emit light with normal colors without the problem of light leakage.

Please refer to FIGS. 1 to 6. FIGS. 4 to 6 are cross-sectional schematic diagrams of some embodiments of the liquid crystal display device 1 in FIG. 2 according to the present disclosure. In some embodiments, the backlight module 10 includes a substrate layer 100, a reflective layer 101, a light guide layer 102, and an edge-lit backlight unit 103. In some embodiments, the substrate layer 100 includes a plurality of sidewalls 100A and a base plate 100B, and the plurality of sidewalls 100A are disposed around the base plate 100B. The substrate layer 100 is used to protect the optical materials in the backlight module 10 and to prevent light from being emitted from places other than the light-emitting surface s11.

In some embodiments, the reflective layer 101 is disposed on the base plate 100B of the substrate layer 100, and the light guide layer 102 is disposed on the reflective layer 101. The reflective layer 101 is used to reflect the light generated by the edge-lit backlight unit 103 to the light guide layer 102, and the light guide layer 102 is used to control and guide the direction of the light so that the light is evenly emitted from the light-emitting surface s11. Here, the light-emitting surface s11 of the backlight module 10 has a uniform and sufficiently bright lighting effect.

As shown in FIG. 4, in some embodiments, the edge-lit backlight unit 103 is disposed on the wall surface of at least one of the plurality of sidewalls 100A of the substrate layer 100. Here, when the edge-lit backlight unit 103 generates light, the edge-lit backlight unit 103 emits the light to the reflective layer 101, and the light is reflected to the light guide layer 102 via the reflective layer 101. Subsequently, the light guide layer 102 controls and guides the direction of the light so that the light enters the quantum dot repairing film 11 and the quantum dot layer 12 for light color conversion. Finally, the light that has completed the light color conversion is emitted from the light-emitting surface s11 of the backlight module 10.

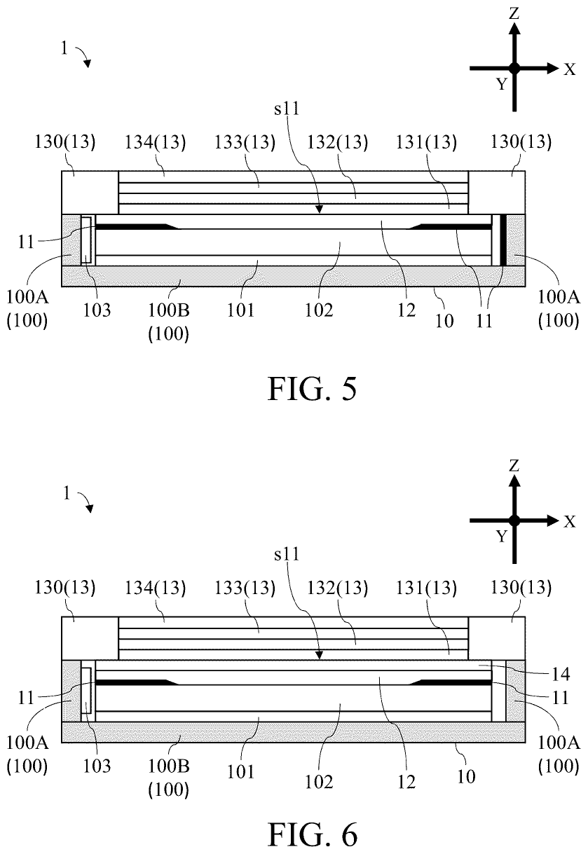

In some embodiments, the quantum dot repairing film 11 is further disposed on the wall surfaces of the remaining sidewalls 100A. Taking FIG. 5 as an example, the edge-lit backlight unit 103 is disposed on the wall surface of one of the sidewalls 100A, and the quantum dot repairing film 11 is further disposed on the wall surfaces of the remaining sidewalls 100A. When part of the light generated by the edge-lit backlight unit 103 enters the quantum dot repairing film 11 located on the wall surface of the sidewall 100A, the quantum dot repairing film 11 located on the wall surface of the sidewall 100A can also perform light color conversion on the light. Here, even if part of the light generated by the edge-lit backlight unit 103 does not directly or indirectly enter the quantum dot repairing film 11 or the quantum dot layer 12 located on the backlight module 10, the liquid crystal display device 1 can still perform light color conversion on part of the light through the quantum dot repairing film 11 located on the wall surface of the sidewall 100A.

As shown in FIG. 6, in some embodiments, the liquid crystal display device 1 further includes an optical film layer 14, and the optical film layer 14 is disposed between the quantum dot layer 12 and the panel module 13. In some embodiments, the optical film layer 14 is used to further adjust the characteristics of the light from the edge-lit backlight unit 103. For example, in some embodiments, the optical film layer 14 may include at least one of a prism sheet (Brightness Enhancement Film, BEF), a diffuser film, and a light guide film, but is not limited thereto. Among them, when the optical film layer 14 is a prism sheet, the optical film layer 14 is used to concentrate the light generated by the edge-lit backlight unit 103 to further improve the brightness of the liquid crystal display device 1.

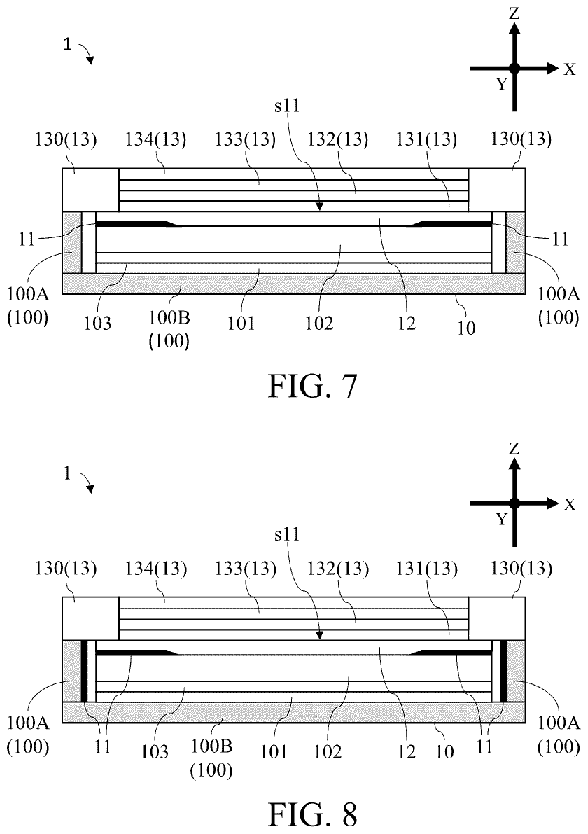

Please refer to FIGS. 1 to 3 and FIGS. 7 to 9. FIGS. 7 to 9 are cross-sectional schematic diagrams of other embodiments of the liquid crystal display device 1 in FIG. 2 according to the present disclosure. In other embodiments, the backlight module 10 includes a substrate layer 100, a reflective layer 101, a light guide layer 102, and a direct-lit backlight unit 103. In some embodiments, the substrate layer 100 includes a plurality of sidewalls 100A and a base plate 100B, and the plurality of sidewalls 100A are disposed around the base plate 100B Among them, the substrate layer 100 is used to protect the optical materials in the backlight module 10 and to prevent light from being emitted from places other than the light-emitting surface s11.

In some embodiments, the reflective layer 101 is disposed on the base plate 100B of the substrate layer 100, and the light guide layer 102 is disposed on the reflective layer 101. The reflective layer 101 is used to reflect the light generated by the direct-lit backlight unit 103 to the light guide layer 102, and the light guide layer 102 is used to control and guide the direction of the light so that the light is emitted evenly from the light-emitting surface s11. Here, the light-emitting surface s11 of the backlight module 10 has a uniform and sufficiently bright lighting effect.

As shown in FIG. 7, in some embodiments, the direct-lit backlight unit 103 is disposed between the reflective layer 101 and the light guide layer 102. Here, when the direct-lit backlight unit 103 generates light, the direct-lit backlight unit 103 emits a part of the light to the light guide layer 102 along the normal of the light-emitting surface s11 (corresponding to the Z direction) and emits another part of the light to the reflective layer 101. The reflective layer 101 reflects the other part of the light to the light guide layer 102. Subsequently, the light guide layer 102 controls and guides the direction of the light so that the light enters the quantum dot repairing film 11 and the quantum dot layer 12 for light color conversion. Finally, the light after light color conversion is emitted from the light-emitting surface s11 of the backlight module 10.

In some embodiments, the quantum dot repairing film 11 is further disposed on the wall surface of each sidewall 100A. Taking FIG. 8 as an example, the quantum dot repairing film 11 is further disposed on the wall surface of each sidewall 100A. Similar to the principle of the previous embodiments, even if some of the light generated by the direct-lit backlight unit 103 does not directly or indirectly enter the quantum dot repairing film 11 or the quantum dot layer 12 on the backlight module 10, the liquid crystal display device 1 can still perform light color conversion on some of the light through the quantum dot repairing film 11 on the wall surface of the sidewall 100A.

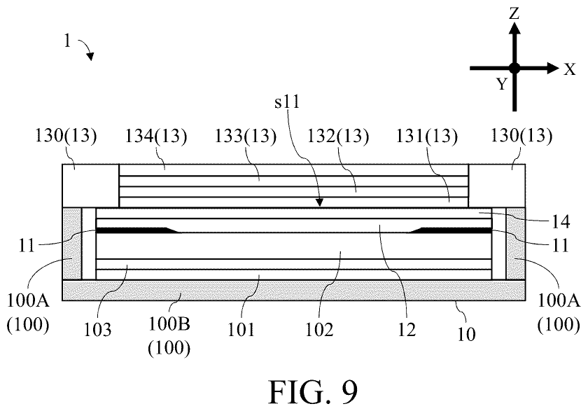

As shown in FIG. 9, in some embodiments, the liquid crystal display device 1 further includes an optical film layer 14, and the optical film layer 14 is disposed between the quantum dot layer 12 and the panel module 13. In some embodiments, the optical film layer 14 is used to further adjust the characteristics of the light from the direct-lit backlight unit 103. For example, in some embodiments, the optical film layer 14 may include at least one of a prism sheet, a diffusion sheet, and a light guide sheet, but is not limited thereto. When the optical film layer 14 is a diffusion sheet, the optical film layer 14 is used to uniformly disperse the light generated by the direct-lit backlight unit 103 to further improve the uniformity of the liquid crystal display device 1.

As shown in FIGS. 4 to 9, in some embodiments, the light-shielding layer 130 is disposed on the quantum dot layer 12 and the sidewall 100A of the substrate layer 100 through an adhesive. In other words, the adhesive is used to bond the backlight module 10 and the panel module 13 together to enhance the tightness between the backlight module 10 and the panel module 13. In addition, the adhesive is also used to isolate the moisture in the air to prevent it from entering the gaps in the backlight module 10. In some embodiments, the adhesive is waterproof to avoid losing its adhesive force and waterproof effect due to the influence of moisture in the air. The adhesive can be, for example, oil-based epoxy or carbamate, but is not limited thereto.

In some embodiments, the panel module 13 includes a polarization layer 131 (hereinafter referred to as the first polarization layer 131), a thin film transistor (TFT) layer 132, a color filter (CF) layer 133, and another polarization layer 134 (hereinafter referred to as the second polarization layer 134). The thin film transistor layer 132 is disposed on the first polarization layer 131, the color filter layer 133 is disposed on the thin film transistor layer 132, and the second polarization layer 134 is disposed on the color filter layer 133. In some embodiments, the thin film transistor layer 132 is used to receive current to generate an electric field change, thereby deflecting the direction of each liquid crystal molecule (not shown in FIGS. 4 to 9) located between the thin film transistor layer 132 and the color filter layer 133 to allow/prohibit light from passing through the thin film transistor layer 132. Here, each liquid crystal molecule can produce a grayscale color effect, and each liquid crystal molecule can be regarded as each pixel in the picture displayed by the liquid crystal display device 1. In addition, in some embodiments, the first polarization layer 131 and the second polarization layer 134 are used to limit the vibration direction of light, thereby screening out light with the same vibration direction. Here, the liquid crystal display device 1 determines the light and dark states of each pixel in the picture it displays through the first polarization layer 131 and the second polarization layer 134. Moreover, in some embodiments, the color filter layer 133 is used to convert the grayscale color effect displayed by each liquid crystal molecule into a color effect. Here, the liquid crystal display device 1 can convert the picture it displays from a grayscale picture to a color picture through the color filter layer 133.

In some embodiments, a sum of a thickness of the first polarization layer 131, a thickness of the thin film transistor layer 132, a thickness of the color filter layer 133, and a thickness of the second polarization layer 134 is equal to a thickness of the light-shielding layer 130, and the light-shielding layer 130 surrounds the first polarization layer 131, the thin film transistor layer 132, the color filter layer 133, and the second polarization layer 134. Here, the surface of the panel module 13 can be kept flat to avoid problems when the liquid crystal display device 1 displays images, and the light-shielding layer 130 can prevent the light from the backlight module 10 from emitting from the side of the panel module 13 and causing light leakage.

In some embodiments, the material of the substrate layer 100 can be a black matrix (BM) material or a light-reflective material, such as but not limited to metallic chromium (Cr), black photosensitive resin, carbon black pigment, black ink, black photoresist, bauxite, dielectric multilayer film, and reflective resin material. In other embodiments, the material of the substrate layer 100 can also be an opaque insulating material, such as but not limited to silicon (Si), silicon dioxide (SiO₂), gallium arsenide (GaAs), and silicon carbide (SiC).

In some embodiments, the edge-lit backlight unit/direct-lit backlight unit 103 includes at least one light-emitting element, such as but not limited to light-emitting diodes (LED), organic light-emitting diodes (OLED), quantum dot light-emitting diodes (QLED), mini light-emitting diodes (Mini LED), and micro light-emitting diodes (Micro LED).

In some embodiments, the quantum dot repairing film 11 comprises a quantum dot material, a transparent material with ductility, and a transparent material with adhesiveness. The transparent material with ductility includes, but is not limited to, silicone, epoxy, benzocyclobutene (BCB), perfluorocyclobutane (PFCB), SU8 photoresist, acrylic resin, polyimide (PI), polyethylene (PE), polyvinyl chloride (PVC), polystyrene (PS), polypropylene (PP), crystallized polypropylene (CPP), oriented polypropylene (OPP), polyethylene terephthalate (PET), polyetherimide, polycarbonate (PC), or polymethyl methacrylate (PMMA). The transparent material with adhesiveness includes, but is not limited to, adhesive, underfill, anisotropic conductive paste (ACP), anisotropic conductive film (ACF), non-conductive paste (NCP), and non-conductive film (NCF).

In some embodiments, the material of the light-shielding layer 130 may be a black matrix (BM) material, such as, but not limited to, metallic chromium (Cr), black photosensitive resin, carbon black pigment, black ink, and black photoresist. In other embodiments, the material of the light-shielding layer 130 may also be a material with light reflectivity, such as, but not limited to, bauxite, dielectric multilayer film, and reflective resin material.

In some embodiments, the materials of the first polarization layer 131 and the second polarization layer 134 include, but are not limited to, tri-acetyl cellulose (TAC), polyvinyl alcohol (PVA), pressure-sensitive adhesive, release film, and protective film.

Referring again to FIGS. 1 and 2, in some embodiments, the liquid crystal display device 1 comprises a backlight module 10, a quantum dot repairing film 11, a quantum dot layer 12, and a panel module 13. In some embodiments, when the backlight module 10 is in use, there may be a problem that multiple conductive traces cross each other and cause a short circuit. In view of this, the following embodiments further describe various light emitting diode circuits and their circuit board structures. In some embodiments, the light emitting diode circuits and their circuit board structures described in the following embodiments can be used to implement or be applied to the backlight module 10. However, the present disclosure is not limited thereto. Under different design considerations or application scenarios, other structures, processes, or manufacturing processes may be adopted to implement the backlight module 10 disclosed in the present disclosure.

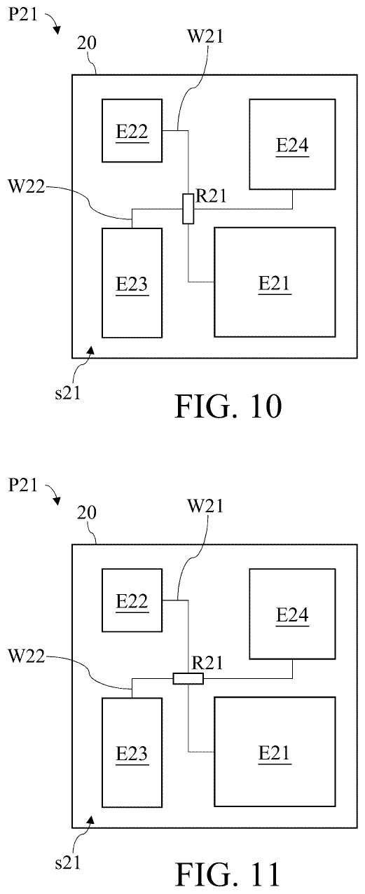

Please refer to FIGS. 10 and 11. FIG. 10 is a schematic diagram of the circuit board structure P21 according to the seventh embodiment of the present disclosure, and FIG. 11 is a schematic diagram of the circuit board structure P21 according to the eighth embodiment of the present disclosure. A circuit board structure includes a circuit board, a plurality of electronic components, a plurality of conductive traces, and at least one resistor. As shown in FIGS. 10 and 11, in some embodiments, the circuit board structure P21 includes a circuit board 20, four electronic components E21, E22, E23, E24 (hereinafter referred to as the first electronic component E21, the second electronic component E22, the third electronic component E23, and the fourth electronic component E24, respectively), two conductive traces W21, W22 (hereinafter referred to as the first conductive trace W21 and the second conductive trace W22, respectively), and one resistor R21 (hereinafter referred to as the first resistor R21).

The circuit board 20 includes a surface s21 (hereinafter referred to as the first surface s21), and the first electronic component E21, the second electronic component E22, the third electronic component E23, the fourth electronic component E24, the first conductive trace W21, and the second conductive trace W22 are all disposed on the first surface s21. In some embodiments, the circuit board 20 may be a single-layer printed circuit board (single-layer PCB) with one conductive layer, a double-layer printed circuit board (double-layer PCB) with two conductive layers, or a multi-layer printed circuit board (multi-layer PCB) with a plurality of conductive layers, but is not limited thereto. In some embodiments, the circuit board structure P21 will be described below by taking a single-layer printed board as an example. It should be noted that, since the circuit board 20 in the circuit board structure P21 only includes one conductive layer (not shown in the figure), both the first conductive trace W21 and the second conductive trace W22 are located on this conductive layer.

In some embodiments, the first electronic component E21 is electrically connected to the second electronic component E22 through the first conductive trace W21, and the third electronic component E23 is electrically connected to the fourth electronic component E24 through the second conductive trace W22. In other words, each conductive trace W21/W22 is used to electrically connect at least two of the plurality of electronic components E21, E22, E23, E24 together. However, since the pin positions of each electronic component E21/E22/E23/E24 are fixed and the circuit board 20 only includes one conductive layer, the first conductive trace W21 and the second conductive trace W22 cross each other and cause a short-circuit. Here, in some embodiments, the first resistor R21 can be disposed on at least one of the plurality of conductive traces W21, W22, and the first resistor R21 is used as a jumper for any section of at least one of the plurality of conductive traces W21, W22.

Taking FIG. 10 as an example, in this embodiment, the first resistor R21 is disposed on the first conductive trace W21 to serve as a jumper for a section of the first conductive trace W21 that crosses the second conductive trace W22, and the second conductive trace W22 maintains its original circuit. In other words, in this embodiment, the first conductive trace W21 can be regarded as two independent conductive traces, and these two conductive traces cross the second conductive trace W22 through the first resistor R21 to be electrically connected together.

Taking FIG. 11 as an example again, in this embodiment, the first resistor R21 is set on the second conductive trace W22 as a jumper for the section of the second conductive trace W22 that intersects with the first conductive trace W21, and the first conductive trace W21 maintains its original circuit. In other words, in this embodiment, the second conductive trace W22 can be regarded as two independent conductive traces, and these two conductive traces are electrically connected together by the first resistor R21 crossing the first conductive trace W21. Here, the circuit board structure P21 can solve the short-circuit problem caused by the intersection between the first conductive trace W21 and the second conductive trace W22 through the first resistor R21 without redesigning the circuit.

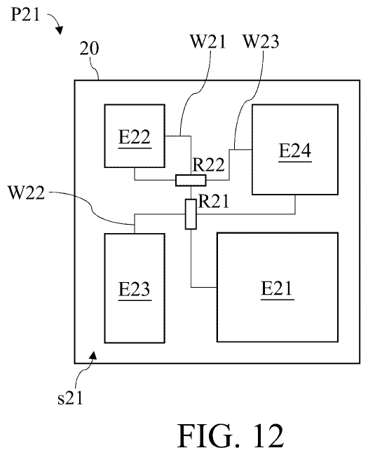

Please further refer to FIG. 12, which is a schematic diagram of the circuit board structure P21 according to the ninth embodiment of the present disclosure. As shown in FIG. 12, in some embodiments, the circuit board structure P21 further includes another conductive trace W23 (hereinafter referred to as the third conductive trace W23) and another resistor R22 (hereinafter referred to as the second resistor R22), and the second electronic component E22 is electrically connected to the fourth electronic component E24 through the third conductive trace W23. The first conductive trace W21 and the third conductive trace W23 intersect and cause a short-circuit. Therefore, the second resistor R22 is set on the third conductive trace W23 as a jumper for the section of the third conductive trace W23 that intersects with the first conductive trace W21, and the first conductive trace W21 maintains its original circuit. In other words, in this embodiment, the third conductive trace W23 can be regarded as two independent conductive traces, and these two conductive traces are electrically connected together by the second resistor R22 crossing the first conductive trace W21. Here, the circuit board structure P21 can solve the short-circuit problem caused by the intersection between the first conductive trace W21 and the second conductive trace W22 and the short-circuit problem caused by the intersection between the first conductive trace W21 and the third conductive trace W23 through the first resistor R21 and the second resistor R22 respectively without redesigning the circuit.

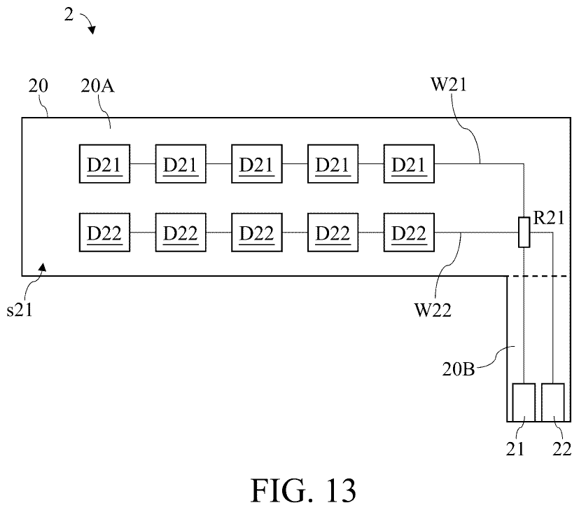

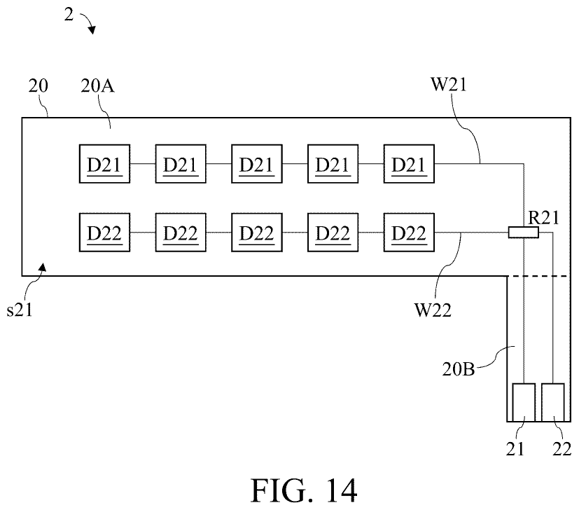

In some embodiments, the circuit board structure P21 can be applied to the light emitting diode (LED) circuit 2. Please refer to FIG. 13 and FIG. 14. FIG. 13 is a schematic diagram of the LED circuit 2 according to the tenth embodiment of the present disclosure, and FIG. 14 is a schematic diagram of the LED circuit 2 according to the eleventh embodiment of the present disclosure. As shown in FIG. 13, in some embodiments, the LED circuit 2 includes a circuit board 20, a plurality of light-emitting units D21 (hereinafter referred to as the first light-emitting units D21), a terminal set 21 (hereinafter referred to as the first terminal set 21), a conductive trace W21 (hereinafter referred to as the first conductive trace W21), a plurality of other light-emitting units D22 (hereinafter referred to as the second light-emitting units D22), another terminal set 22 (hereinafter referred to as the second terminal set 22), another conductive trace W22 (hereinafter referred to as the second conductive trace W22), and at least one resistor R21. Taking FIG. 13 and FIG. 14 as an example, in this embodiment, the LED circuit 2 includes one resistor R21 (hereinafter referred to as the first resistor R21).

The circuit board 20 includes a surface s21 (hereinafter referred to as the first surface s21), and the plurality of first light-emitting units D21, the first terminal set 21, the first conductive trace W21, the plurality of second light-emitting units D22, the second terminal set 22, and the second conductive trace W22 are all disposed on the first surface s21. Similar to the circuit board 20 in the circuit board structure P21, in some embodiments, the circuit board 20 in the LED circuit 2 can be a single-layer printed circuit board with one conductive layer, a double-layer printed circuit board with two conductive layers, or a multi-layer printed circuit board with a plurality of conductive layers, but is not limited thereto. In some embodiments, the LED circuit 2 will be described below by taking a single-layer printed board as an example. It should be noted that, since the circuit board 20 in the LED circuit 2 only includes one conductive layer (not shown in the figure), both the first conductive trace W21 and the second conductive trace W22 are located on this conductive layer.

In some embodiments, the circuit board 20 includes a first section 20A and a second section 20B vertically connected to the first section 20A, and the first section 20A is longer than the second section 20B. In addition, in some embodiments, the plurality of light-emitting units D21 are located in the first section 20A, and the first terminal set 21 and the second terminal set 22 are located in the second section 20B. In some embodiments, since the light-emitting elements (including the first light-emitting units D21 and the second light-emitting units D22) and the terminal sets (including the first terminal set 21 and the second terminal set 22) in the LED circuit 2 are respectively located in different sections of the circuit board 20, the user can easily weld or insert the second section 20B of the circuit board 20 that includes the terminal sets onto an electronic device, so that this electronic device can have a lighting function or a display function through the LED circuit 2.

In some embodiments, the first conductive trace W21 is used to electrically connect the plurality of first light-emitting units D21 and the first terminal set 21 together, and the second conductive trace W22 is used to electrically connect the plurality of second light-emitting units D22 and the second terminal set 22 together. However, since the pins of each light-emitting unit D21/D22 and the positions of each terminal set 21/22 are fixed and the circuit board 20 only contains one conductive layer, the first conductive trace W21 and the second conductive trace W22 cross each other and cause a short circuit. Here, in some embodiments, the first resistor R21 can be arranged on the first conductive trace W21 and/or the second conductive trace W22, and the first resistor R21 is used as a jumper for any section of the first conductive trace W21 and/or the second conductive trace W22.

Taking FIG. 13 as an example, in this embodiment, the first resistor R21 is arranged on the first conductive trace W21 to serve as a jumper for the section of the first conductive trace W21 that crosses the second conductive trace W22, and the second conductive trace W22 maintains the original circuit. In other words, in this embodiment, the first conductive trace W21 can be regarded as two independent conductive traces, and these two conductive traces are electrically connected together by the first resistor R21 across the second conductive trace W22.

Taking FIG. 14 as another example, in this embodiment, the first resistor R21 is arranged on the second conductive trace W22 to serve as a jumper for the section of the second conductive trace W22 that crosses the first conductive trace W21, and the first conductive trace W21 maintains the original circuit. In other words, in this embodiment, the second conductive trace W22 can be regarded as two independent conductive traces, and these two conductive traces are electrically connected together by the first resistor R21 across the first conductive trace W21. Here, the LED circuit 2 can solve the problem of short circuit caused by the crossing of the first conductive trace W21 and the second conductive trace W22 through the first resistor R21 without redesigning the circuit.

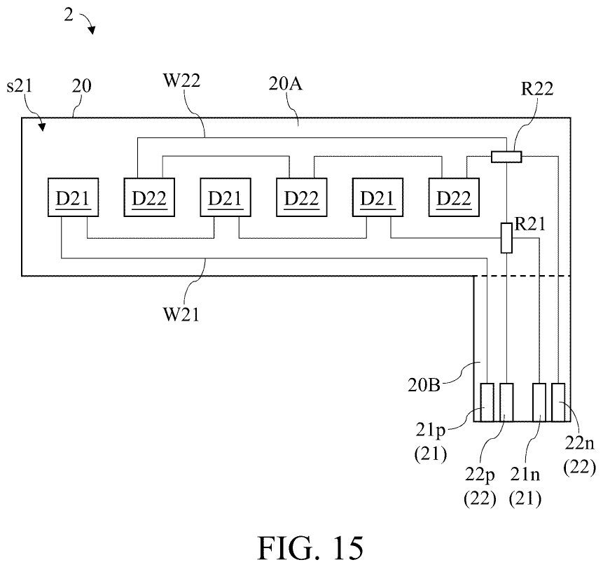

Please further refer to FIG. 15, which is a schematic diagram of a LED circuit 2 according to the twelfth embodiment of the present disclosure. As shown in FIG. 15, in some embodiments, the first terminal set 21 includes a positive electrode 21p (hereinafter referred to as the first positive electrode 21p) and a negative electrode 21n (hereinafter referred to as the first negative electrode 21n), and the second terminal set 22 includes another positive electrode 22p (hereinafter referred to as the second positive electrode 22p) and another negative electrode 22n (hereinafter referred to as the second negative electrode 22n). In addition, in some embodiments, the first positive electrode 21p and the first negative electrode 21n are respectively disposed at the two ends of the first conductive trace W21, and the second positive electrode 22p and the second negative electrode 22n are respectively disposed at the two ends of the second conductive trace W22. In other words, the plurality of first light-emitting units D21 are located on the circuit between the first positive electrode 21p and the first negative electrode 21n, and the plurality of second light-emitting units D22 are located on the circuit between the second positive electrode 22p and the second negative electrode 22n.

In some embodiments, the plurality of first light-emitting units D21 and the plurality of second light-emitting units D22 are alternately arranged with each other to form an array. Here, the user can alternately control the plurality of first light-emitting units D21 and the plurality of second light-emitting units D22 to produce various lighting effects or display effects. However, since the pins of each light-emitting unit D21/D22, the positions of each positive electrode 21p/22p and each negative electrode 21n/22n are fixed and the circuit board 20 only includes one conductive layer, the first conductive trace W21 and the second conductive trace W22 cross each other and cause a short circuit, and a section and another section of the second conductive trace W22 also cross each other and cause a short circuit. Here, in some embodiments, the LED circuit 2 further includes another resistor R22 (hereinafter referred to as the second resistor R22) to be disposed on the first conductive trace W21 and/or the second conductive trace W22, and the second resistor R22 is used as a jumper for any section of the first conductive trace W21 and/or the second conductive trace W22.

Taking FIG. 15 as an example, in this embodiment, the first resistor R21 is disposed on the second conductive trace W22 to serve as a jumper for a section of the second conductive trace W22 that crosses the first conductive trace W21, and the second resistor R22 is also disposed on the second conductive trace W22 to serve as a jumper for a section of the second conductive trace W22 that crosses another section of the second conductive trace W22. Here, the second conductive trace W22 can avoid crossing the first conductive trace W21 and itself to cause a short circuit, so as to maintain the circuit between the second positive electrode 22p and the second negative electrode 22n.

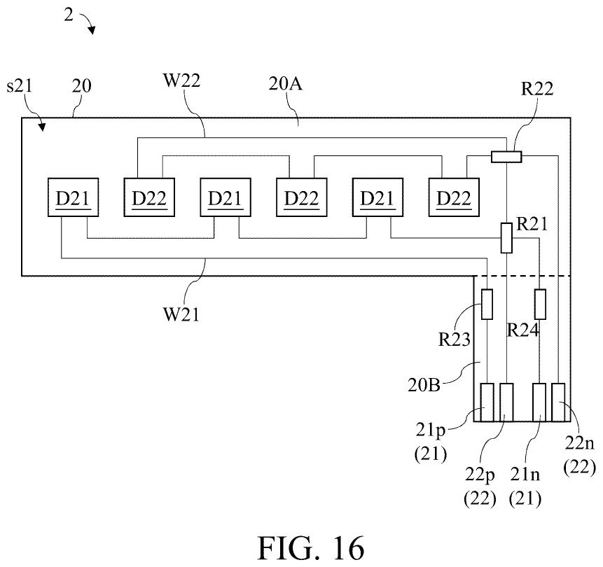

Please refer to FIG. 16. FIG. 16 is a schematic diagram of the LED circuit 2 according to the thirteenth embodiment of the present disclosure. In some embodiments, the resistor is further used to replace any section of the first conductive trace W21 or any section of the second conductive trace W22. Taking FIG. 16 as an example, in this embodiment, the LED circuit 2 further includes two resistors R23 and R24 (hereinafter referred to as the third resistor R23 and the fourth resistor R24, respectively). Since the first resistor R21 and the second resistor R22 are arranged on the second conductive trace W22, the resistance value of the circuit between the second positive electrode 22p and the second negative electrode 22n (i.e., the second conductive trace W22) is higher than that of the circuit between the first positive electrode 21p and the first negative electrode 21n (i.e., the first conductive trace W21). Here, when a fixed voltage is applied to the LED circuit 2 to make the plurality of first light-emitting units D21 and the plurality of second light-emitting units D22 emit light, the light-emitting effect of each light-emitting unit D21/D22 on the LED circuit 2 will be affected by the resistance value and vary, which further makes the light-emitting effect or display effect of the LED circuit 2 uneven. Therefore, in some embodiments, the third resistor R23 and the fourth resistor R24 are arranged on the first conductive trace W21 so that the resistance value of the circuit between the first positive electrode 21p and the first negative electrode 21n is equal to that of the circuit between the second positive electrode 22p and the second negative electrode 22n. At this time, when this fixed voltage is applied to the LED circuit 2 to make the plurality of first light-emitting units D21 and the plurality of second light-emitting units D22 emit light, the light-emitting effect of each light-emitting unit D21/D22 on the LED circuit 2 is the same, which further makes the light-emitting effect or display effect of the LED circuit 2 average.

In some embodiments, the first electronic component E21, the second electronic component E22, the third electronic component E23, and the fourth electronic component E24 can be any kind of integrated circuit (IC), packaged chip, or semiconductor component, such as but not limited to a central processing unit (CPU), a system-on-chip (SoC), a microprocessor, a digital signal processor (DSP), a complex programmable logic device (CPLD), a field programmable gate array (FPGA), an application specific integrated circuit (ASIC), a microcontroller unit (MCU), a light-emitting diode (LED), a diode, a bipolar junction transistor (BJT), Metal-Oxide-Semiconductor Field-Effect-Transistor (MOSFET), resistor, capacitor, and inductor.

In some embodiments, the first light-emitting unit D21 and the second light-emitting unit D22 may be, but not limited to, light-emitting diodes, organic light-emitting diodes (Organic LED, OLED), quantum-dot light-emitting diodes (Quantum-dot LED, QLED), mini light-emitting diodes (Mini LED), or micro light-emitting diodes (Micro LED).

Referring again to FIG. 1 and FIG. 2, in some embodiments, a liquid crystal display device (LCD device) 1 includes a backlight module 10, a quantum dot repairing film 11, a quantum dot layer 12, and a panel module 13. In some embodiments, when the backlight module 10 is in use, when multiple switches are actuated simultaneously, since each switch is turned on and off instantaneously, the voltage of each switch will be instantaneously pulled up and dropped suddenly. As a result, the power supply circuit that supplies power to the scanning circuit will generate a resonance phenomenon, resulting in the problem of low-frequency noise. In view of this, the following embodiments further describe various LED backlight panels. In some embodiments, the LED backlight panels of the following embodiments can be used to implement or be applied to the backlight module 10. However, the present disclosure is not limited to this. Under different design considerations or application scenarios, other structures, processes, or manufacturing processes can be adopted to implement the backlight module 10 disclosed in the present disclosure.

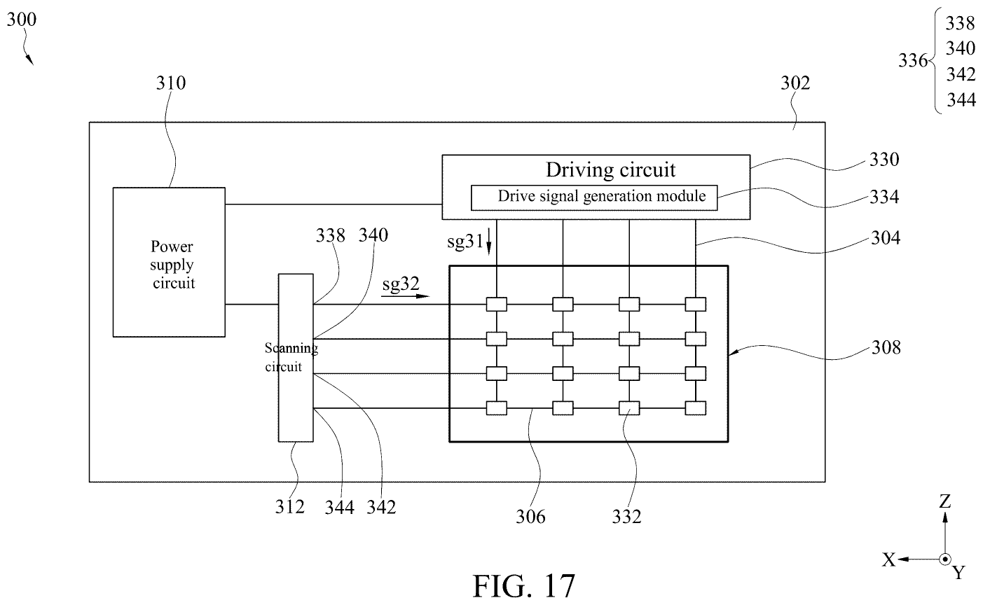

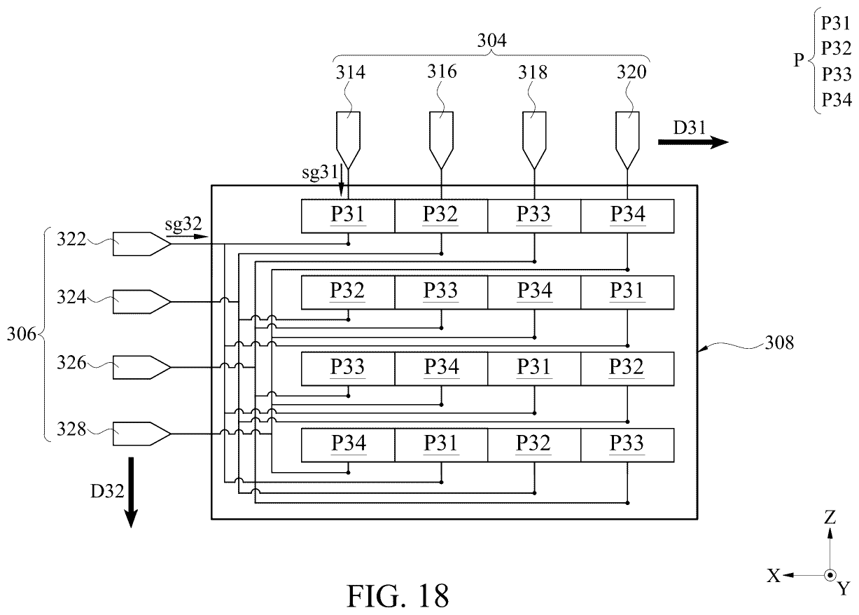

As shown in FIG. 17 and FIG. 18, in some embodiments, an LED backlight panel 300 includes a circuit board 302, a plurality of drive lines 304, and a plurality of scan lines 306.

The circuit board 302 has an operable area (Active Area) 308. The control circuit of the circuit board 302 is used to control the light emission at a specified position in the operable area 308 to display a preset visual effect in the operable area 308.

The drive lines 304 are located on the circuit board 302 and are sequentially arranged on the operable area 308 in the first arrangement direction D31. The drive lines 304 are the wiring arranged in the first arrangement direction D31 on the operable area 308. It should be noted that the drive signal sg31 can be transmitted via the drive lines 304 to the specified light emission point P (to be described later) on the operable area 308 to control the brightness and emission time of the light emitted by the specified light emission point P.

The scan lines 306 are located on the circuit board 302 and define a plurality of light emission points P in a matrix configuration with these drive lines 304 on the operable area 308. The relative positions of the multiple light emission points P formed by the same scan line 306 and these drive lines 304 (such as the multiple light emission points P31, or the multiple light emission points P32, or the multiple light emission points P33, or the multiple light emission points P34 shown in FIG. 18) are staggered from each other in the second arrangement direction D32.

The scan signal sg32 of the circuit board 302 can be transmitted to the operable area 308 via the specified scan line 306, so that the light emission point P electrically connected to the specified scan line 306 can obtain the scan signal sg32. In some embodiments, the scan signal sg32 can turn on the switch electrically connected to the light emission point P, so that the light emission point P corresponding to the scan line 306 connected to the turned-on switch can obtain the drive signal sg31 (to be described later). Conversely, the scan line 306 that does not send the scan signal sg32 fails to turn on the switch, so that the light emission point P on this scan line 306 will not obtain the drive signal sg31 (the light emission point P that does not obtain the scan signal sg32 will not emit light).

In some embodiments, the first arrangement direction D31 is different from the second arrangement direction D32. As shown in FIG. 18, the first arrangement direction D31 is perpendicular to the second arrangement direction D32.

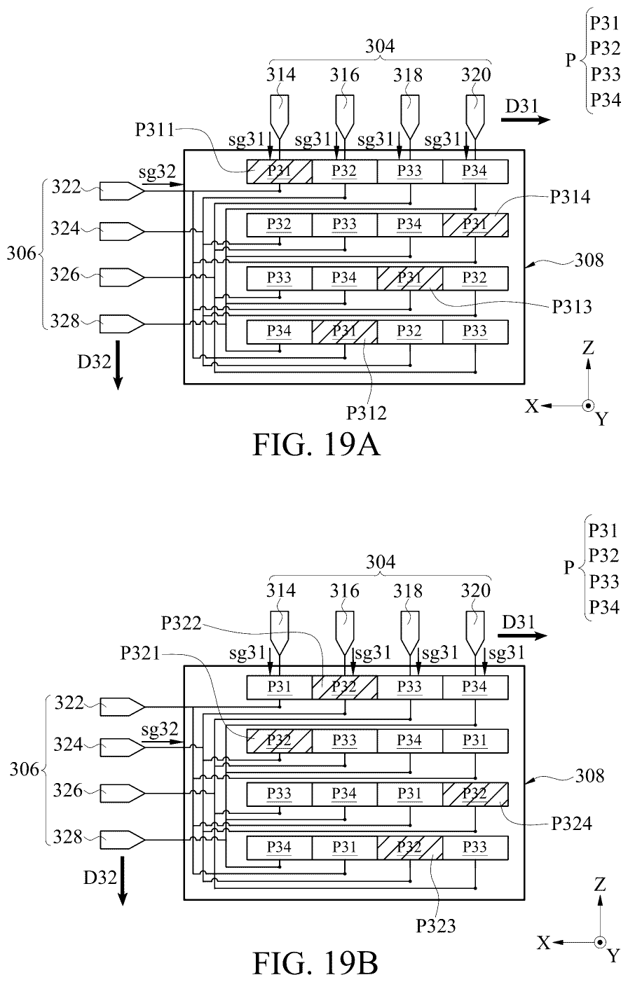

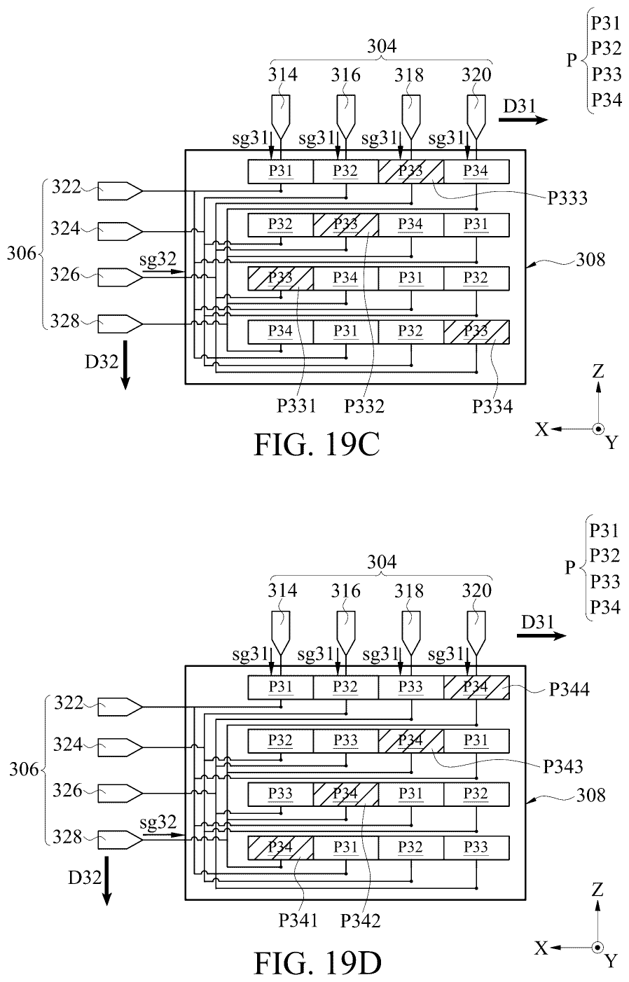

In some embodiments, the scan signal sg32 is sequentially sent to the designated scan lines 306 according to the scanning sequence. Specifically, in the same scanning sequence, only one light emission point P in the light emission points P formed by each drive line 304 receives the scan signal sg32, and these light emission points P that receive the same scan signal sg32 are distributed at different sequential positions on the corresponding drive lines 304. That is to say, the positions of these light emission points P that receive the same scan signal sg32 on the corresponding drive lines 304 are relatively sorted in the second arrangement direction D32 (examples will be given later in FIG. 19A, FIG. 19B, FIG. 19C, or FIG. 19D).

In some embodiments, the circuit board 302 includes a power supply circuit 310. The power supply circuit 310 is located on the circuit board 302 and is coupled to these drive lines 304 and these scan lines 306 to supply power. In the same scanning sequence, the adjacent light emission points P arranged in the same row will not receive the scan signal sg32 simultaneously, so that multiple switches electrically connected to the light emission points P in the same row will not operate (turn on and off) simultaneously. Here, the voltage change caused by each switch connected to the same scan line 306 to the power supply circuit 310 can be reduced to suppress the resonance phenomenon of the resonant elements in the power supply circuit 310.

In some embodiments, the LED backlight panel 300 can use a preset number of scan lines 306 as a light emission point scan group. At the beginning of a scanning sequence, each light emission point P in the same light emission point scan group can receive the scan signal sg32 respectively (details will be described later).

In some embodiments, as shown in FIG. 17 and FIG. 18, the LED backlight panel 300 also includes a scanning circuit 312. The scanning circuit 312 is located on the circuit board 302 and is coupled to these scan lines 306. The scanning circuit 312 is used to send the scan signal sg32 to these scan lines 306. In each scanning sequence, the scanning circuit 312 sends the scan signal sg32 to one of these scan lines 306, and the arrangement order of multiple light emission points P among these light emission points P that receive the scan signal sg32 on these drive lines 304 is staggered from each other.

In some embodiments, as shown in FIG. 18, take four drive lines 304 (hereinafter referred to as the first drive line 314, the second drive line 316, the third drive line 318, and the fourth drive line 320 respectively) and four scan lines 306 (hereinafter referred to as the first scan line 322, the second scan line 324, the third scan line 326, and the fourth scan line 328 respectively) as an example. The first drive line 314, the second drive line 316, the third drive line 318, and the fourth drive line 320 are sequentially arranged in the operable area 308 along the first arrangement direction D31. The first scan line 322, the second scan line 324, the third scan line 326, and the fourth scan line 328 are sequentially arranged in the operable area 308 along the second arrangement direction D32. Here, the LED backlight panel 300 needs to perform four scans in one scan cycle. In other words, in one scan cycle, the first scan line 322, the second scan line 324, the third scan line 326, and the fourth scan line 328 will all send a scan signal sg32 once.

In some embodiments, these light emission points P can be divided into multiple first light emission points P31, multiple second light emission points P32, multiple third light emission points P33, and multiple fourth light emission points P34 according to the scanning sequence. The following description takes FIG. 18, FIG. 19A, FIG. 19B, FIG. 19C, or FIG. 19D as an example.

In some embodiments, the intersections of the first scan line 322 with the first drive line 314, the second drive line 316, the third drive line 318, and the fourth drive line 320 are these first light emission points P31. As shown in the first light emission point P31 in FIG. 19A, the first light emission point P31 where the first scan line 322 intersects the first drive line 314 is the first light emission point P311, the first light emission point P31 where the first scan line 322 intersects the second drive line 316 is the first light emission point P312, the first light emission point P31 where the first scan line 322 intersects the third drive line 318 is the first light emission point P313, and the first light emission point P31 where the first scan line 322 intersects the fourth drive line 320 is the first light emission point P314.

In some embodiments, the intersections of the second scan line 324 with the first drive line 314, the second drive line 316, the third drive line 318, and the fourth drive line 320 are these second light emission points P32. As shown in the second light emission point P32 in FIG. 19B, the second light emission point P32 where the second scan line 324 intersects the first drive line 314 is the second light emission point P321, the second light emission point P32 where the second scan line 324 intersects the second drive line 316 is the second light emission point P322, the second light emission point P32 where the second scan line 324 intersects the third drive line 318 is the second light emission point P323, and the second light emission point P32 where the second scan line 324 intersects the fourth drive line 320 is the second light emission point P324.

In some embodiments, the third scan line 326 intersects the first drive line 314 and the second drive line 316, the third drive line 318, and the fourth drive line 320 correspond to these third light emission points P33. As shown in the third light emission points P33 in FIG. 19C, the third light emission point P33 where the third scan line 326 intersects the first drive line 314 is the third light emission point P331, the third light emission point P33 where the third scan line 326 intersects the second drive line 316 is the third light emission point P332, the third light emission point P33 where the third scan line 326 intersects the third drive line 318 is the third light emission point P333, and the third light emission point P33 where the third scan line 326 intersects the fourth drive line 320 is the third light emission point P334.

In some embodiments, the fourth scan line 328 intersects the first drive line 314, the second drive line 316, the third drive line 318, and the fourth drive line 320, corresponding to these fourth light emission points P34. As shown in the fourth light emission points P34 in FIG. 19D, the fourth light emission point P34 where the fourth scan line 328 intersects the first drive line 314 is the fourth light emission point P341, the fourth light emission point P34 where the fourth scan line 328 intersects the second drive line 316 is the fourth light emission point P342, the fourth light emission point P34 where the fourth scan line 328 intersects the third drive line 318 is the fourth light emission point P343, and the fourth light emission point P34 where the fourth scan line 328 intersects the fourth drive line 320 is the fourth light emission point P344.

In some embodiments, as shown in FIG. 19A, during the first scanning sequence, the first scan line 322 sends the scan signal sg32, and the first light emission points (P311, P312, P313, P314) on the first scan line 322 receive the scan signal sg32; as shown in FIG. 19B, during the second scanning sequence, the second scan line 324 sends the scan signal sg32, and the second light emission points (P321, P322, P323, P324) on the second scan line 324 receive the scan signal sg32; as shown in FIG. 19C, during the third scanning sequence, the third scan line 326 sends the scan signal sg32, and the third light emission points (P331, P332, P333, P334) on the third scan line 326 receive the scan signal sg32; as shown in FIG. 19D, during the fourth scanning sequence, the fourth scan line 328 sends the scan signal sg32, and these fourth light emission points (P341, P342, P343, P344) on the fourth scan line 328 receive the scan signal sg32. Here, when the LED backlight panel 300 scans the 16 light emission points P in this example, only four scans are needed to scan all the light emission points P without increasing the scanning rate. In each scanning sequence, when the first light emission points (P311, P312, P313, P314), the second light emission points (P321, P322, P323, P324), the third light emission points (P331, P332, P333, P334), or the fourth light emission points (P341, P342, P343, P344) that receive the scan signal sg32 emit light, the arrangement order on each drive line 304 is staggered from each other. In this way, the switches connected to adjacent light emission points P do not operate (turn on and off) simultaneously, and the power supply circuit 310 does not generate resonance, so as to suppress the resonance noise of the power supply circuit 310.

In some embodiments, the LED backlight panel 300 also includes a driving circuit 330. The driving circuit 330 is coupled to these drive lines 304 (see FIG. 17) and is used to send the drive signal sg31 to these drive lines 304.

In some embodiments, the LED backlight panel 300 further includes multiple light emitting diodes 332. The multiple light emitting diodes 332 are respectively coupled to the intersection positions of these drive lines 304 and these scan lines 306 that define the light emission points P, and are used to emit light according to the drive signal sg31. For example, after completing a scanning task (the end of the first scanning sequence, the second scanning sequence, the third scanning sequence, and the fourth scanning sequence), these drive lines 304 can sequentially send the drive signal sg31 to the specified drive lines 304, and the light emission points P that receive the scan signal sg32 can receive the drive signal sg31. Conversely, the light emission points P that do not receive the scan signal sg32 will not receive the drive signal sg31. As a result, these light emission points P that receive the scan signal sg32 can emit light according to the drive signal sg31. For another example, the LED backlight panel 300 can also send the drive signal sg31 before performing the scanning task. In some embodiments, these drive lines 304 can be the first drive line 314, the second drive line 316, the third drive line 318, or the fourth drive line 320 in some embodiments, and these scan lines 306 can be the first scan line 322, the second scan line 324, the third scan line 326, or the fourth scan line 328 in some embodiments (as shown in FIG. 18, FIG. 19A, FIG. 19B, FIG. 19C, or FIG. 19D).

In some embodiments, the driving circuit 330 includes a drive signal generation module 334. The drive signal generation module 334 has multiple transmission channels and is used to generate the drive signal sg31. In some embodiments, the number of these transmission channels is a multiple of the number of these scan lines 306. For example, if the drive signal generation module 334 has 64 transmission channels and the number of scan lines 306 is 4 (such as the first scan line 322, the second scan line 324, the third scan line 326, and the fourth scan line 328 in some embodiments), the drive signal generation module 334 can control the number of drive lines 304 to be 16. In other words, the LED backlight panel 300 in this example can be configured with 16 drive lines 304 and 4 scan lines 306, and the number of light emitting diodes 332 can be configured to be 64.

In some embodiments, as shown in FIG. 17, the scanning circuit 312 further includes multiple scan switches 336. These scan switches 336 are configured between the drive signal generation module 334 and each light emission point P on these scan lines 306. When these scan switches 336 are turned on, the scan signal sg32 is sent to each light emission point P on the specified scan line 306. Here, these scan switches 336 can be turned on in response to the scan signal sg32 to transmit the scan signal sg32. In some embodiments, the scan switch 336 can be a Metal-Oxide-Semiconductor Field-Effect Transistor (MOSFET).

In some embodiments, these scan switches 336 are respectively connected to each light emission point P on these drive lines 304 in a one-to-one manner. In other words, the number of scan switches 336 can be configured according to the number of each light emission point P on the scan line 306.

In some embodiments, taking four scan lines 306 as an example, these scan switches 336 include a first scan switch 338, a second scan switch 340, a third scan switch 342, and a fourth scan switch 344. The first scan switch 338 is coupled to each light emission point P on the first scan line 322. The second scan switch 340 is coupled to each light emission point P on the second scan line 324. The third scan switch 342 is coupled to each light emission point P on the third scan line 326. The fourth scan switch 344 is coupled to each light emission point P on the fourth scan line 328. For example, when the drive signal generation module 334 sends the scan signal sg32 to the first scan line 322, the first scan switch 338 is turned on in response to the scan signal sg32, so that the scan signal sg32 can be sent to the specified first light emission points P31 (such as the first light emission points P311, P312, P313, P314) through the first scan line 322. It should be noted that the drive signal generation module 334 can turn on the first scan switch 338, the second scan switch 340, the third scan switch 342, and the fourth scan switch 344 according to the scanning sequence. For example, in the first scanning sequence, the drive signal generation module 334 sends the scan signal sg32 to the first scan switch 338 to turn on the first scan switch 338. Among them, the second scan switch 340, the third scan switch 342, and the fourth scan switch 344 remain off. Accordingly, in the first scanning sequence, only the first scan line 322 sends the scan signal sg32. In some embodiments, the drive signal generation module 334 can also send a switch signal to drive these scan switches 336 to turn on.

Taking the scan switch 336 as a MOSFET as an example, when the first scan line 322 sends the scan signal sg32, the scan signal sg32 can trigger the gate of the first scan switch 338, causing the source and drain of the first scan switch 338 to conduct. If the first drive line 314 sends the drive signal sg31, the first light emission point P311 where the first scan line 322 intersects the first drive line 314 can be lit up.

In some embodiments, the circuit board 302 can be a printed circuit board or a flexible circuit board.

In some embodiments, the light emitting diodes 332 can be micro light emitting diodes (Micro LED), mini light emitting diodes (Mini LED), or organic light emitting diodes (OLED). In some embodiments, the light emitting diodes 332 with the same wavelength can be respectively arranged at each light emission point P, or the light emitting diodes 332 with different wavelengths can be respectively arranged at each light emission point P.

Referring again to FIG. 1 and FIG. 2, in some embodiments, the liquid crystal display device 1 includes a backlight module 10, a quantum dot repairing film 11, a quantum dot layer 12, and a panel module 13. In some embodiments, when the panel module 13 is in use, it may happen that the materials of the conductive gold balls are different from the materials of each layer in the thin-film transistor liquid crystal substrate, and when forming the conductive gold balls on the thin-film transistor liquid crystal substrate, the instruments and materials of the process need to be replaced to perform the step of forming the conductive gold balls, which makes the panel manufacturing process complicated and time-consuming. In view of this, the following embodiments further describe various thin-film transistor liquid crystal panel units and manufacturing methods of the thin-film transistor liquid crystal panel units. In some embodiments, the thin-film transistor liquid crystal panel units and the manufacturing methods of the thin-film transistor liquid crystal panel units in the following embodiments can be used to implement or be applied to the panel module 13. However, the present disclosure is not limited to this. Under different design considerations or application scenarios, other structures, processes, or manufacturing processes can be adopted to implement the panel module 13 disclosed in the present disclosure.

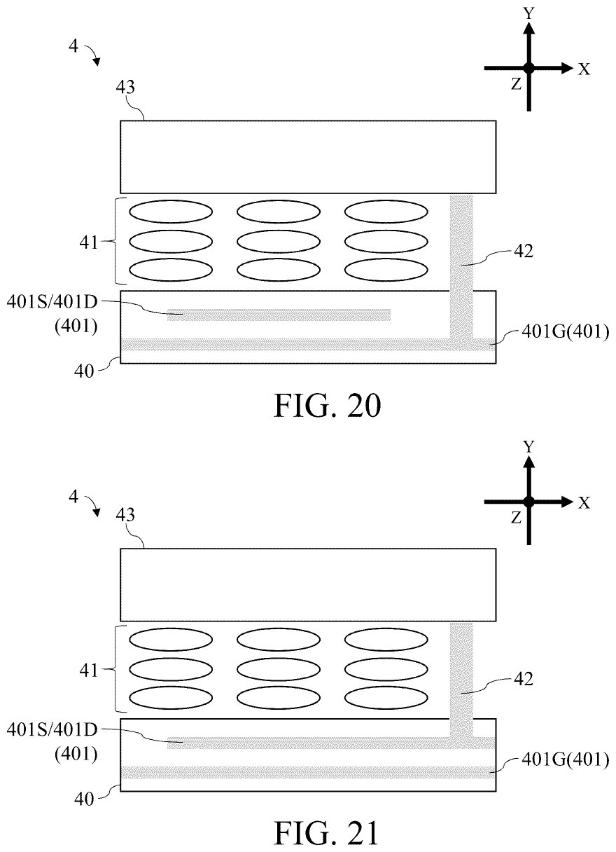

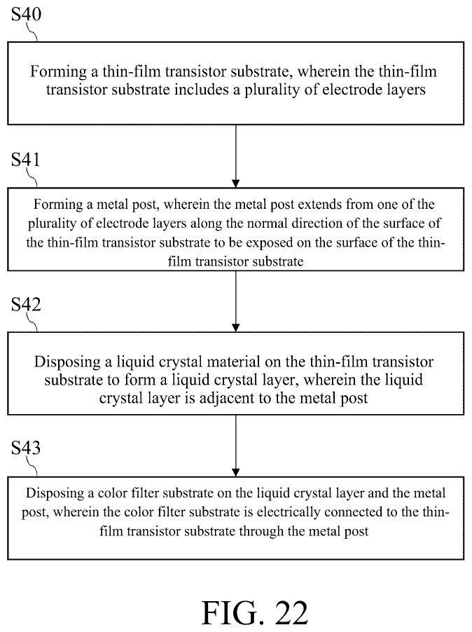

Please refer to FIGS. 20 to 22. FIGS. 20 and 21 are side plan views of different embodiments of the thin-film transistor liquid crystal display (TFT-LCD) panel unit 4 respectively, and FIG. 22 is an operation flowchart of the manufacturing method of the TFT-LCD panel unit 4. A TFT-LCD panel unit 4 is suitable for forming a TFT-LCD panel or a TFT-LCD display. As shown in FIGS. 20 and 21, the TFT-LCD panel unit 4 includes a thin-film transistor (TFT) substrate 40, a liquid crystal layer 41, a metal post 42, and a color filter substrate 43. The thin-film transistor substrate 40 includes a plurality of electrode layers 401. The liquid crystal layer 41 is disposed on a surface of the thin-film transistor substrate 40. The metal post 42 extends from one of the plurality of electrode layers 401 along a normal direction of the surface of the thin-film transistor substrate 40 (corresponding to the Y direction in the rectangular coordinate system) to be exposed on the surface of the thin-film transistor substrate 40, and the metal post 42 is adjacent to the liquid crystal layer 41. The color filter substrate 43 is disposed on the liquid crystal layer 41 and the metal post 42 and is electrically connected to the thin-film transistor substrate 40 through the metal post 42.

The following will take FIGS. 20 and 21 as examples to illustrate the manufacturing method of the TFT-LCD panel unit 4. As shown in FIG. 22, in some embodiments, first, the thin-film transistor substrate 40 is formed (step S40. The detailed steps of step S40 will be described later), wherein the thin-film transistor substrate 40 includes a plurality of electrode layers 401. Then, the metal post 42 is formed (step S41), wherein the metal post 42 extends from one of the plurality of electrode layers 401 along the normal direction (Y direction) of the surface of the thin-film transistor substrate 40 to be exposed on the surface of the thin-film transistor substrate 40. In other words, a bottom surface of the metal post 42 is directly coupled to one of the plurality of electrode layers 401, rather than directly coupled to the surface of the thin-film transistor substrate 40.

After step S41, a liquid crystal material is disposed on the thin-film transistor (TFT) substrate 40 to form a liquid crystal layer 41, wherein the liquid crystal layer 41 is adjacent to the metal post 42 (step S42), and a thickness of the liquid crystal layer 41 is approximately equal to a height of the metal post 42 exposed on the surface of the thin-film transistor substrate 40. Finally, a color filter substrate 43 is disposed on the liquid crystal layer 41 and the metal post 42, wherein the color filter substrate 43 is electrically connected to the thin-film transistor substrate 40 through the metal post 42 (step S43). Here, the manufacturing process of the TFT-LCD panel unit 4 can be completed. In some embodiments, the manufacturing method of the color filter substrate 43 is well-known to those skilled in the art to which this disclosure pertains, so it will not be described in detail.

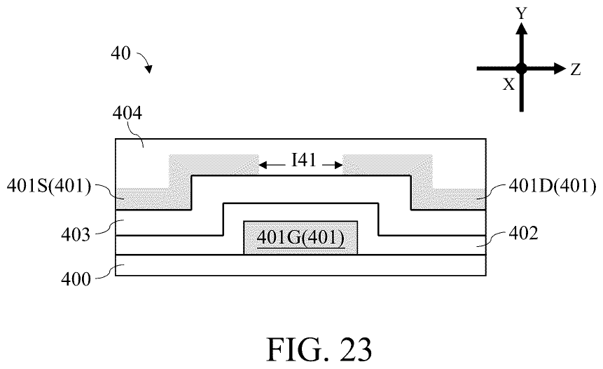

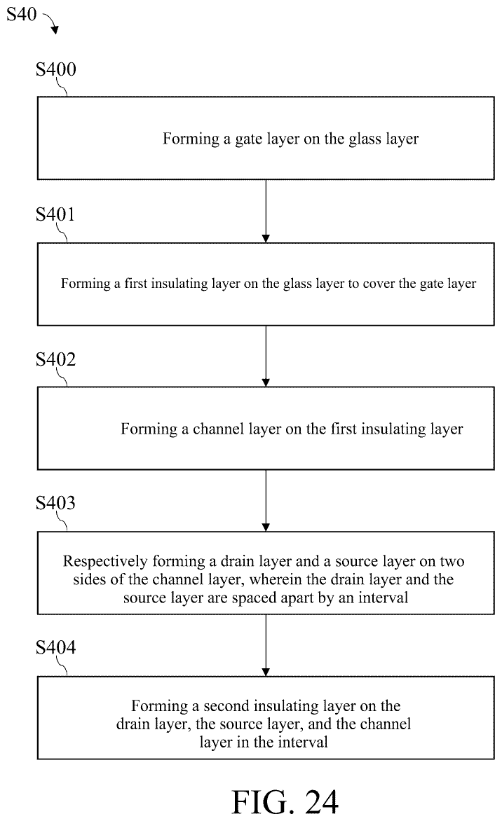

Please further refer to FIGS. 23 and 24. FIG. 23 is a side plan view of an embodiment of the thin-film transistor substrate 40, and FIG. 24 is an operational flowchart of a manufacturing method of the thin-film transistor substrate 40. As shown in FIG. 23, in some embodiments, the plurality of electrode layers 401 in the thin-film transistor substrate 40 include a gate layer 401G, a drain layer 401D, and a source layer 401S. In other words, the metal post 42 extends from the gate layer 401G, the drain layer 401D, or the source layer 401S to be exposed on the surface of the thin-film transistor substrate 40. Taking FIG. 20 as an example, in this embodiment, the metal post 42 extends from the gate layer 401G to be exposed on the surface of the thin-film transistor substrate 40. Taking FIG. 21 as an example, in this embodiment, the metal post 42 extends from the drain layer 401D or the source layer 401S to be exposed on the surface of the thin-film transistor substrate 40.

In some embodiments, the TFT substrate 40 further includes a glass layer 400, an insulating layer 402 (hereinafter referred to as the first insulating layer 402), a channel layer 403, and another insulating layer 404 (hereinafter referred to as the second insulating layer 404). In some embodiments, the gate layer 401G is disposed on the glass layer 400, and the first insulating layer 402 is disposed on the glass layer 400 to cover the gate layer 401G. In other words, the gate layer 401G is disposed between the glass layer 400 and the first insulating layer 402. In some embodiments, the channel layer 403 is disposed on the first insulating layer 402, wherein the drain layer 401D and the source layer 401S are respectively disposed on two sides of the channel layer 403 and are spaced apart by an interval 141. In other words, the channel layer 403 in the interval 141 is not covered by the drain layer 401D and the source layer 401S. In some embodiments, the second insulating layer 404 is disposed on the drain layer 401D, the source layer 401S, and the channel layer 403 in the interval 141.

The following will take FIG. 23 as an example to illustrate the manufacturing method of the TFT substrate 40. As shown in FIG. 24, in step S40, first, a gate layer 401G is formed on the glass layer 400 (step S400). Then, a first insulating layer 402 is formed on the glass layer 400 to cover the gate layer 401G (step S401), and a channel layer 403 is formed on the first insulating layer 402 (step S402). Subsequently, a drain layer 401D and a source layer 401S are respectively formed on two sides of the channel layer 403, wherein the drain layer 401D and the source layer 401S are spaced apart by an interval 141 (step S403). Finally, the second insulating layer 404 is formed on the drain layer 401D, the source layer 401S, and the channel layer 403 in the interval 141 (step S404).

It should be noted that, in some embodiments, the viewing angle of the TFT-LCD panel unit 4 shown in FIGS. 20 and 21 corresponds to the XY plane in the Cartesian coordinate system, and the viewing angle of the TFT-LCD panel unit 4 shown in FIG. 23 corresponds to the YZ plane in the Cartesian coordinate system. In other words, the gate layer 401G, drain layer 401D, and source layer 401S shown in FIG. 23 extend along the X direction (as shown in FIGS. 20 and 21). Here, the metal post 42 extends along the normal direction (Y direction) of the surface of the thin-film transistor substrate 40 and from the extended gate layer 401G/drain layer 401D/source layer 401S to be exposed on the surface of the thin-film transistor substrate 40.

In some embodiments, the metal post 42 and the plurality of electrode layers 401, the first insulating layer 402, the channel layer 403, and the second insulating layer 404 in the thin-film transistor substrate 40 can be formed through deposition techniques. The deposition techniques include, but are not limited to, sputtering technology, electron beam evaporation technology, chemical vapor deposition (CVD) technology, physical vapor deposition (PVD) technology, area selective deposition (ASD) technology, and atomic layer deposition (ALD) technology.

In some embodiments, the material of the metal post 42 is the same as that of one of the plurality of electrode layers 401. In other words, the material of the metal post 42 is the same as the material of the gate layer 401G, the drain layer 401D, or the source layer 401S. In addition, since the material of the metal post 42 is the same as that of one of the plurality of electrode layers 401, the step of forming the metal post 42 (step S41) is synchronized with the step of forming the gate layer 401G, the drain layer 401D, or the source layer 401S. In other words, in response to the completion of the formation of the gate layer 401G/drain layer 401D/source layer 401S, the metal post 42 is subsequently formed to extend from the gate layer 401G/drain layer 401D/source layer 401S, and the metal post 42 will be exposed on the surface of the second insulating layer 404 (corresponding to the surface of the thin-film transistor substrate 40) after the formation of the second insulating layer 404 is completed. Here, the thin-film transistor substrate 40 can form the metal post 42, the gate layer 401G, the drain layer 401D, and the source layer 401S through the same set of process instruments and materials to save the cost of replacing process instruments and materials.

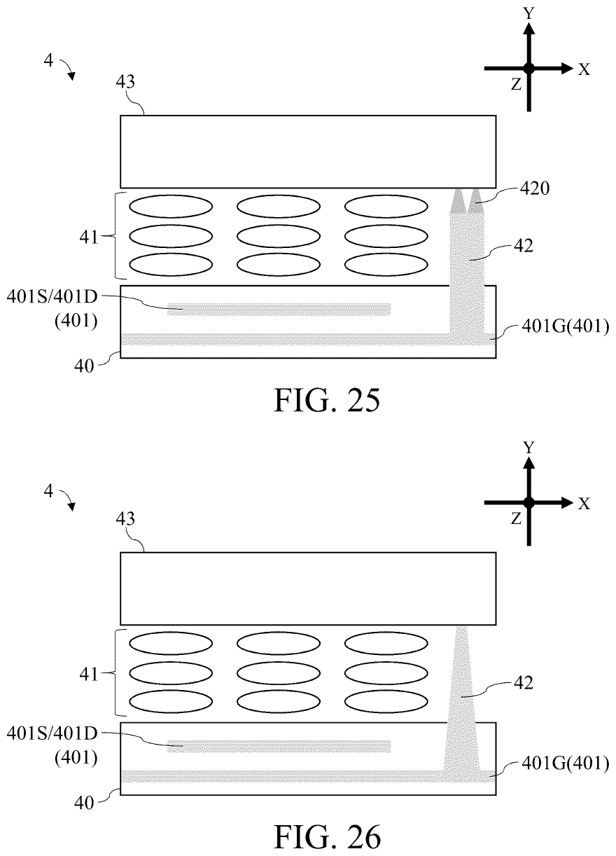

In some embodiments, the materials of the electrode layer 401, the metal post 42, and the metal truncated cone 420 (which will be described in detail later in FIG. 25) can be various types of metals or alloys, such as but not limited to copper (Cu), aluminum (Al), copper-chromium-zirconium (CuCrZr) alloy, aluminum-zirconium (AlZr) alloy, beryllium-copper (BeCu) alloy, tungsten-copper (WCu) alloy, and silver-copper (AgCu) alloy. It should be noted that the materials of the electrode layer 401, the metal post 42, and the metal truncated cone 420 can also be gold (Au). However, due to the high cost of gold, it is not suitable to be used as the material for the electrode layer 401, the metal post 42, and the metal truncated cone 420.

Please refer to FIG. 20 and FIG. 21 again. In some embodiments, the metal post 42 is a cylinder, wherein the bottom surface of the metal post 42 is coupled to the surface of one of the plurality of electrode layers 401, and a top surface of the metal post 42 is coupled to the color filter substrate 43. In addition, in some embodiments, the cylindrical metal post 42 can be formed through repeated deposition. Taking FIG. 20 as an example, in this embodiment, the bottom surface of the metal post 42 is coupled to the surface of the gate layer 401G. Taking FIG. 21 as an example, in this embodiment, the bottom surface of the metal post 42 is coupled to the surface of the drain layer 401D/source layer 401S.

Please refer to FIG. 25, which is a schematic side view of another embodiment of the TFT-LCD panel unit 4. In some embodiments, the metal post 42 further includes at least one metal truncated cone 420. A bottom surface of the at least one metal truncated cone 420 is coupled to the top surface of the metal post 42, and a top surface of the at least one metal truncated cone 420 is coupled to the color filter substrate 43. Taking FIG. 25 as an example, in this embodiment, the metal post 42 further includes two metal truncated cones 420. In some embodiments, the metal truncated cone 420 can be formed through repeated deposition, and the area of each deposition gradually decreases. Among them, when the area of the top surface of the metal truncated cone 420 is smaller, it means that the metal truncated cone 420 gradually approximates a cone. Here, the metal truncated cone 420 can penetrate the insulating layer in the color filter substrate 43 to be directly coupled to the conductive film layer in the color filter substrate 43, thereby electrically connecting the thin-film transistor substrate 40 to the color filter substrate 43.

Please refer to FIG. 26. FIG. 26 is a schematic side view of yet another embodiment of the TFT-LCD panel unit 4. In some embodiments, the metal post 42 is a truncated cone, wherein the bottom surface of the metal post 42 is coupled to the surface of one of the plurality of electrode layers 401, and the top surface of the metal post 42 is coupled to the color filter substrate 43. In some embodiments, the truncated cone-shaped metal post 42 can be formed through repeated depositions, and the area of each deposition gradually decreases. Here, when the area of the top surface of the metal post 42 is smaller, it means that the metal post 42 gradually approximates a cone. Here, the metal post 42 can penetrate the insulating layer in the color filter substrate 43 to be directly coupled to the conductive film layer in the color filter substrate 43, thereby electrically connecting the thin-film transistor substrate 40 to the color filter substrate 43.

Please refer to FIG. 23 again. In some embodiments, the materials of the first insulating layer 402 and the second insulating layer 404 have insulating properties, such as but not limited to glass, silicon (Si), silicon dioxide (SiO₂), gallium arsenide (GaAs), silicon carbide (SiC), silicone, epoxy resin, polyimide (PI), benzocyclobutene (BCB), perfluorocyclobutane (PFCB), SU8 photoresist, acrylic resin, polyethylene terephthalate (PET), and polyetherimide.

In some embodiments, the material of the channel layer 403 can be a semiconductor material, such as but not limited to silicon (Si), amorphous silicon, single-crystalline silicon (a-silicon), poly-silicon, gallium arsenide (GaAs), indium phosphide (InP), silicon carbide (SiC), and gallium nitride (GaN).

Referring to FIG. 1 and FIG. 2 again, in some embodiments, a liquid crystal display device 1 includes a backlight module 10, a quantum dot repairing film 11, a quantum dot layer 12, and a panel module 13. In some embodiments, when the panel module 13 is in use, there may be a problem that since the thin-film transistors and/or color filters included in the panel module 13 are made of thin glass materials, the panel is prone to breakage or cracking during cutting or disconnection, which affects the quality of the liquid crystal display. In view of this, the following embodiments further describe various panel manufacturing methods. In some embodiments, the panel manufacturing methods described in the following embodiments can be used to implement or apply to the panel module 13. However, the present disclosure is not limited thereto. Under different design considerations or application scenarios, other structures, processes, or manufacturing processes can be used to implement the panel module 13 disclosed in the present disclosure.

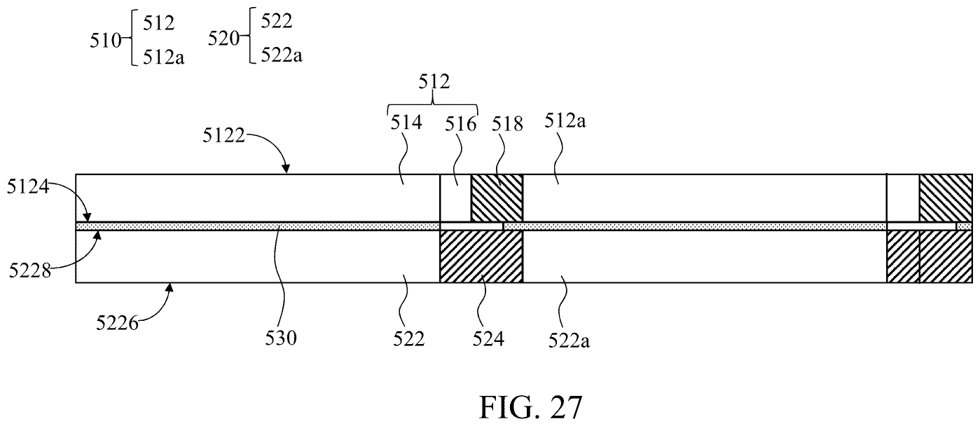

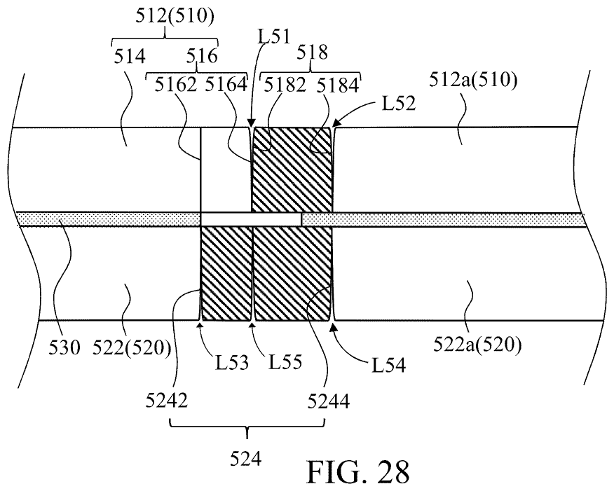

Please refer to FIG. 27 and FIG. 28. FIG. 27 is a schematic diagram of a panel according to some embodiments of the present disclosure, and FIG. 28 is a schematic diagram of the positions of each cutting line according to some embodiments of the present disclosure. The panel manufacturing method includes: cutting on a first substrate 510 to form a first cutting line L51; cutting at different positions on the first substrate 510 to form a second cutting line L52, wherein there is a first excess material 518 between the first cutting line L51 and the second cutting line L52; cutting on a second substrate 520 adjacent to the first substrate 510 to form a third cutting line L53; cutting at different positions on the second substrate 520 to form a fourth cutting line L54, wherein there is a second excess material 524 between the third cutting line L53 and the fourth cutting line L54; finally, cutting the second excess material 524 to form a fifth cutting line L55. When the fifth cutting line L55 is formed, the first substrate 510 and the second substrate 520 will break at the first cutting line L51, the second cutting line L52, the third cutting line L53, and the fourth cutting line L54.

The first substrate 510 includes a display area 514 and a terminal area 516. The terminal area 516 has a first end 5162 and a second end 5164. The first end 5162 of the terminal area 516 is connected to the display area 514, and the second end 5164 of the terminal area 516 is connected to the first excess material 518. The first cutting line L51 is located at the second end 5164 of the terminal area 516. Specifically, the first cutting line L51 is formed between the second end 5164 of the terminal area 516 and the first excess material 518. The second cutting line L52 is located on the other side of the first excess material 518 relative to the first cutting line L51.

The third cutting line L53 corresponds to the first end 5162 of the terminal area 516. That is, when the third cutting line L53 is formed by cutting the second substrate 520, it is aligned in the second substrate 520 opposite to the connection between the terminal area 516 and the display area 514 in the first substrate 510. The fourth cutting line L54 corresponds to the second cutting line L52 in the first substrate 510, and the fifth cutting line L55 corresponds to the first cutting line L51. That is, the fifth cutting line L55 is aligned in the second substrate 520 opposite to the position between the second end 5164 of the terminal area 516 and the first excess material 518 in the first substrate 510.

Please refer to FIG. 28 again. In some embodiments, the first substrate 510 includes a plurality of first sub-substrates 512 adjacent to each other, and each first sub-substrate 512 is connected to each other by the first excess material 518. Each first sub-substrate 512 includes a display area 514 and a terminal area 516. Each first excess material 518 includes a first side 5182 and a second side 5184 opposite to each other. Each first sub-substrate 512 is connected to the first side 5182 of the first excess material 518 by the second end 5164 of the terminal area 516, and is connected to another adjacent first sub-substrate 512a by the second side 5184 of the first excess material 518.

In some embodiments, the second substrate 520 includes a plurality of second sub-substrates 522 adjacent to each other. The second sub-substrates 522 are connected by the second excess material 524. The second excess material 524 has a third side 5242 and a fourth side 5244 opposite to each other respectively. Each second sub-substrate 522 is connected to the third side 5242 of a second excess material 524 respectively, and is connected to the fourth side 5244 of the second excess material 524 by another adjacent second sub-substrate 522a.

Please refer to FIG. 27 again. In some embodiments, the first substrate 510 has a first upper surface 5122 and a first lower surface 5124 opposite to each other. When cutting the first substrate 510 to generate the first cutting line L51 and the second cutting line L52 respectively, the first upper surface 5122 of the first substrate 510 is cut.

In some embodiments, the second substrate 520 has a second upper surface 5226 and a second lower surface 5228 opposite to each other. The second lower surface 5228 is attached to the first lower surface 5124 of the first substrate 510. When cutting the second substrate 520 to generate the third cutting line L53 and the fourth cutting line L54 respectively, the second upper surface 5226 of the second substrate 520 is cut.

Please refer to FIG. 28 again. During cutting, the cutter wheel can be pressed against the positions where the first cutting line L51, the second cutting line L52, the third cutting line L53, the fourth cutting line L54 or the fifth cutting line L55 are expected to be generated respectively, and the cutter wheel is moved relatively at these positions to scribe a scribe groove on the first substrate 510 or the second substrate 520. The scribe grooves formed by cutting cause vertical cracks in the first substrate 510 or the second substrate 520, that is, the first substrate 510 or the second substrate 520 is partially broken at the scribe grooves. Specifically, at the first cutting line L51 and the second cutting line L52, there is a partial break between the first upper surface 5122 and the first lower surface 5124 of the first substrate 510, and this break extends from the first upper surface 5122 to the first lower surface 5124. The depth of the scribe groove (that is, the distance of the break between the first upper surface 5122 and the first lower surface 5124) can vary depending on the angle, tooth depth, number of teeth of the cutter wheel and the thickness of the backing paper used when cutting with the cutter wheel. However, the depth of this scribe groove does not cause the first cutting line L51 or the second cutting line L52 to break immediately during cutting, and pressure must be applied to the first cutting line L51 or the second cutting line L52 to make it break.

Similarly, at the third cutting line L53 and the fourth cutting line L54, there is a partial break between the second upper surface 5226 and the second lower surface 5228 of the second substrate 520. This break extends from the second upper surface 5226 towards the second lower surface 5228. The depth of the cutting line is such that the third cutting line L53 or the fourth cutting line L54 does not break immediately during cutting, and pressure needs to be applied to the third cutting line L53 or the fourth cutting line L54 to make it break.

In some embodiments, when cutting the second excess material 524 to create the fifth cutting line L55, the first cutting line L51, the second cutting line L52, the third cutting line L53, and the fourth cutting line L54 can be subjected to the force generated when the cutter wheel presses against the second excess material 524, and then break. Since the first cutting line L51 is the connection between the first sub-substrate 512 and the first excess material 518, and the second cutting line L52 is the connection between another first sub-substrate 512a and the first excess material 518, when the first cutting line L51 and the second cutting line L52 break, separation will occur between two adjacent first sub-substrates 512 and 512a in the first substrate 510 and the first excess material 518.

The third cutting line L53 is the connection between the second sub-substrate 522 and the second excess material 524, and the fourth cutting line L54 is the connection between another second sub-substrate 522a and the second excess material 524. When the third cutting line L53 and the fourth cutting line L54 break, separation will occur between two adjacent second sub-substrates 522 and 522a in the second substrate 520 and the second excess material 524.

In some embodiments, after the first excess material 518 or the second excess material 524 is separated from the first sub-substrate 512 or the second sub-substrate 522, it is removed as waste.

In some embodiments, the first substrate 510 can use a peripheral sealant 530 to bond the display area 514 of each first sub-substrate 512 to the second substrate 520. When the first cutting line L51, the second cutting line L52, the third cutting line L53, and the fourth cutting line L54 are all separated, the bonding between the first sub-substrate 512 and the second sub-substrate 522 will be maintained. In addition, since the position of the third cutting line L53 corresponds to the first end 5162 of the terminal area 516 of the first sub-substrate 512, the terminal area 516 of the first sub-substrate 512 is adjacent to the second excess material 524 of the second substrate 520, and there is no peripheral sealant 530 coated between the terminal area 516 and the second excess material 524. Therefore, when the third cutting line L53 breaks and the second sub-substrate 522 is separated from the second excess material 524, the terminal area 516 of the first sub-substrate 512 will be exposed to the outside.

In some embodiments, the first substrate 510 is a thin film transistor (TFT) substrate, and the second substrate 520 is a color filter (CF). The thin-film transistor substrate and the color filter form the mother board of the liquid crystal display panel. Cutting the mother board can separate it into a plurality of unit substrates that meet the terminal requirements of the liquid crystal display. After the first cutting line L51, the second cutting line L52, the third cutting line L53, and the fourth cutting line L54 are all separated, the first sub-substrate 512 and the second sub-substrate 522, which are separated from another adjacent first sub-substrate 512a and another adjacent second sub-substrate 522a but still attached to each other, are the above-mentioned unit substrates.

In some embodiments, liquid crystal is sealed in each unit substrate. The liquid crystal is located between the display area 514 of the first sub-substrate 512 and the second sub-substrate 522. The peripheral sealant 530 not only bonds the display area 514 and the second sub-substrate 522 together but also forms a sealed space between them, and the liquid crystal is placed in this sealed space.

In some embodiments, the terminal area 516 connected to the display area 514 is used to set signal lines for electrical connection with external signal terminals. Thus, the cut unit substrate can receive external signals through the terminal area 516. Therefore, after the first sub-substrate 512 is separated from the first excess material 518, the terminal area 516 needs to be exposed to the outside.

In some embodiments, after cutting the first substrate 510 and the second substrate 520 respectively to form the first cutting line L51, the second cutting line L52, the third cutting line L53, and the fourth cutting line L54, if pressure is applied to each cutting line (such as breaking the panel), each cutting line will break, thereby achieving the effect of separating each first sub-substrate 512 and each second sub-substrate 522.

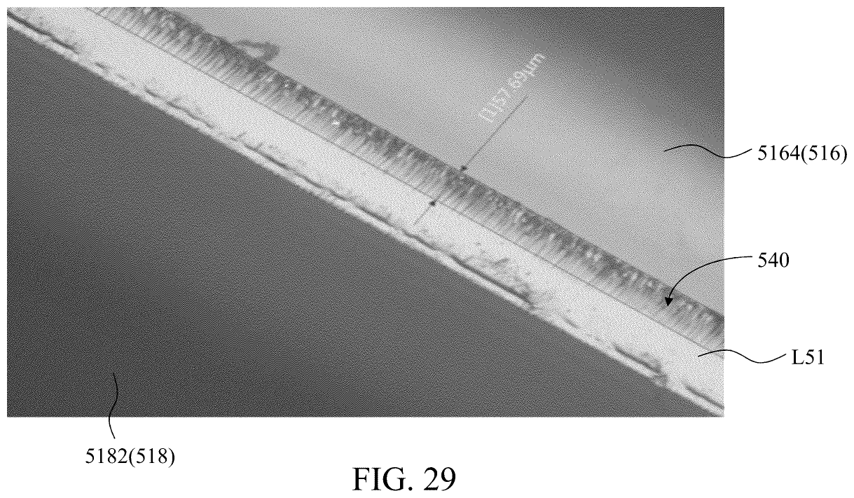

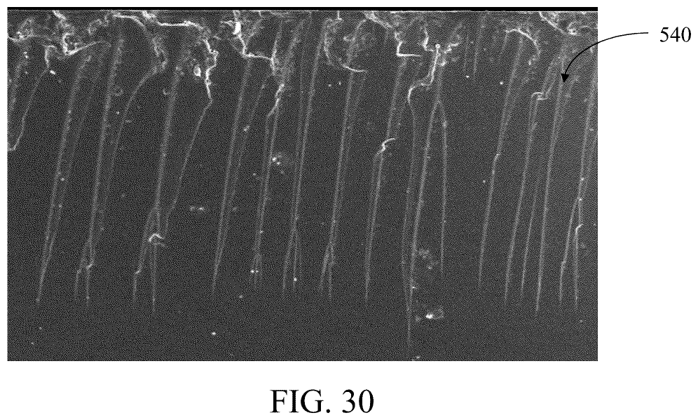

However, since there is no peripheral sealant 530 between the terminal area 516 of the first substrate 510 and the second substrate 520, there is a lack of supporting force from the peripheral sealant 530 under the terminal area 516. When the cutter wheel cuts the area where the first cutting line L51 is expected to be formed, the penetration may be insufficient, resulting in a shallow depth of the vertical crack of the first cutting line L51. If pressure is applied to each cutting line to separate each first sub-substrate 512 after the cutter wheel cuts to form the fourth cutting line L54, it is easy to cause horizontal cracks in the terminal area 516 of the first sub-substrate 512. Please refer to FIGS. 29 and 30. FIG. 29 is a microscopic image of the feather crack on the cutting section of the terminal area according to some embodiments of the present disclosure, and FIG. 30 is an electron microscopic image of the feather crack on the cutting section of the terminal area according to some embodiments of the present disclosure. The direction of the horizontal crack is perpendicular to the direction of the vertical crack formed by each cutting line and presents a feather shape (hereinafter referred to as the feather crack 540).

In some embodiments, the feather cracks 540 cause many uneven marks on the surface of the cutting section of the terminal area 516, making this surface uneven. This uneven surface may affect the reliability of the subsequent product integrated by the first sub-substrate 512 and the second sub-substrate 522.

Specifically, these feather cracks 540 may weaken the mechanical strength of the first sub-substrate 512. During the subsequent processing, assembly, or use of the first sub-substrate 512, these feather cracks 540 may further expand, leading to structural damage to the first sub-substrate 512.

As mentioned before, the terminal area 516 of the first sub-substrate 512 can be used to electrically connect with external signal lines so that the first sub-substrate 512 can obtain signals. The feather cracks 540 may cause the surface quality of the area in the terminal area 516 used for bonding with the signal lines to decline, resulting in poor bonding. This may further lead to problems such as open circuits, short circuits, or unstable signal transmission in the product integrated by the first sub-substrate 512.

Please refer to FIG. 28 again. If the second excess material 524 is cut with a cutter wheel to form the fifth cutting line L55 after the fourth cutting line L54 is formed by cutter wheel cutting, the generation of feather cracks 540 can be reduced while the first cutting line L51 breaks to separate each first sub-substrate 512.

As mentioned before, there is partial fracture between the first upper surface 5122 and the first lower surface 5124 of the first substrate 510 at the first cutting line L51 and the second cutting line L52. There is partial fracture between the second upper surface 5226 and the second lower surface 5228 of the second substrate 520 at the third cutting line L53 and the fourth cutting line L54. Pressure needs to be applied to the first cutting line L51, the second cutting line L52, the third cutting line L53, or the fourth cutting line L54 to make them break and achieve the effect of separating each first sub-substrate 512 from the first excess material 518 and each second sub-substrate 522 from the second excess material 524.

When the second excess material 524 is cut by the cutter wheel to generate the fifth cutting line L55, the stress generated by the cutter wheel cutting will be applied to the position where the fifth cutting line L55 is generated on the second excess material 524. This stress will be evenly transmitted to both sides of the fifth cutting line L55. The third cutting line L53 and the fourth cutting line L54 are located on both sides of the fifth cutting line L55, which promotes the breakage of the third cutting line L53 and the fourth cutting line L54 under pressure.

At the same time, the position of the fifth cutting line L55 is aligned with the position of the first cutting line L51. When the cutter wheel applies force to the second substrate 520, the first cutting line L51 will also be subjected to uniform pressure and break naturally, thus avoiding the generation of the feather cracks 540 that are easily formed when pressure is directly applied to the first cutting line L51 to make it break.

Please refer to Table 1 below (listed at the end of the text). Table 1 below shows that in one embodiment (single-sided substrate thickness of 150 μm), when the first cutting line L51 is broken by means such as breaking immediately after the fourth cutting line L54 is formed by cutting with a cutter wheel, the depth and quantity of feather cracks generated in the terminal area 516 of the first sub-substrate 512.

It can be seen that in this case, the number of feather cracks generated in the terminal area 516 of the first sub-substrate 512 is 695 pieces. Among them, 619 pieces have a feather crack depth of less than 50 μm, accounting for 22.82% of the total number, and 76 pieces have a feather crack depth greater than 50 μm, accounting for 2.79% of the total number.

Referring to Table 2 below (listed at the end of the text), Table 2 below shows that in one embodiment, when the fifth cutting line L55 is cut with a cutter wheel and the first cutting line L51 is naturally broken by stress, the depth and quantity of feather cracks generated in the terminal area 516 of the first sub-substrate 512.

When the number of the first sub-substrates is 1000 pieces, 23 pieces have a feather crack depth of less than 50 μm, and the maximum crack depth is 12 μm, that is, there is no feather crack with a depth greater than 50 μm. It can be seen that separating the terminal area 516 of the first sub-substrate 512 and the first excess material 518 by cutting in this way can significantly reduce the number and depth of feather cracks.

In some embodiments, when the cutter wheel cuts the second excess material 524 of the second sub-substrate 522 to form the fifth cutting line L55, the force applied by the cutter wheel to the position where the fifth cutting line L55 is generated can be 3 Newtons, and the cutting depth is 0.5 millimeters, so that the force received by the first cutting line L51 is 3/3.2 Newtons for natural fracture. In some embodiments, the cutting force, cutting depth of the cutter wheel and the pressure received by the cutting line are not limited.

Referring again to FIGS. 1 and 2, in some embodiments, the liquid crystal display device 1 includes a backlight module 10, a quantum dot repairing film 11, a quantum dot layer 12 and a panel module 13. In some embodiments, when the panel module 13 is applied, there may be a problem that the display must provide stable and consistent picture quality under different usage scenarios. In view of this, the following embodiments further describe various image processing methods and image processing panels. In some embodiments, the image processing methods and image processing panels of the following embodiments can be used to implement or be applied to the panel module 13. However, the present disclosure is not limited to this. Under different design considerations or application scenarios, other structures, processes or manufacturing processes can be used to implement the panel module 13 disclosed in the present disclosure.

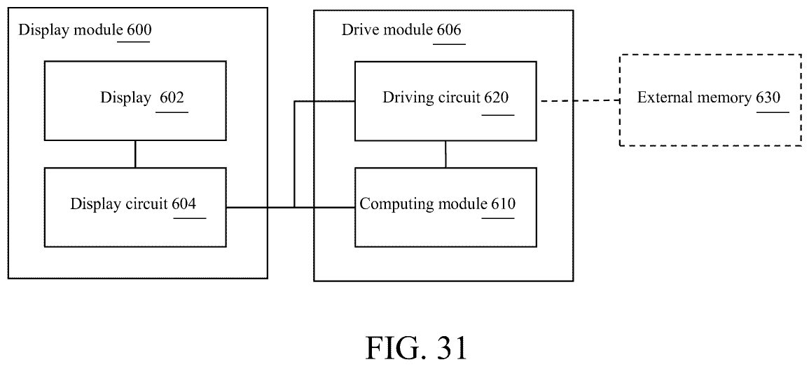

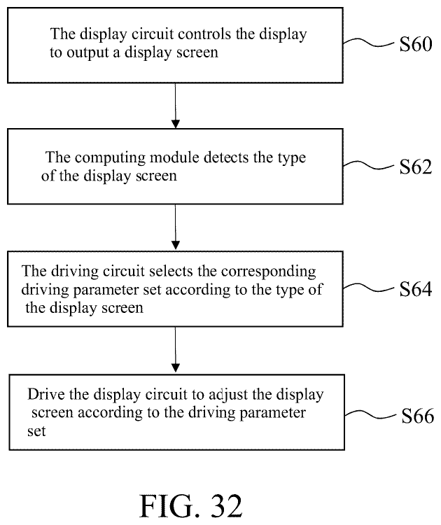

Please refer to FIG. 31 and FIG. 32. FIG. 31 is a functional block diagram of an image processing panel according to some embodiments of the present disclosure, and FIG. 32 is a flowchart of an image processing method according to some embodiments of the present disclosure. The image processing panel includes a display module 600 and a drive module 606. The display module 600 includes a display 602 and a display circuit 604. The display circuit 604 is electrically connected to the display 602 to control the display 602 to output a display screen (step S60). The drive module 606 is electrically connected to the display circuit 604, and the drive module 606 includes a computing module 610 and a driving circuit 620. The computing module 610 is electrically connected to the driving circuit 620. The computing module 610 is used to detect the type of the display screen displayed by the display 602 (step S62). The driving circuit 620 is electrically connected to the computing module 610 and the display module 600. A plurality of driving parameter sets are set in the driving circuit 620. The driving circuit 620 selects the corresponding driving parameter set according to the type of the display screen (step S64), and drives the display circuit 604 to adjust the display screen according to the driving parameter set (step S66).

In some embodiments, when the display module 600 is operating, the display circuit 604 will receive image signals from an input source, and control the display 602 to output a display screen according to these signals, so as to convert the image signals into a visible screen for the user to view.

In some embodiments, the display screen includes multiple types, such as a first type and a second type. Each type can be determined according to the display characteristics of the screen when the display circuit 604 outputs the display screen on the display 602. For example, the first type is a normal display screen, and the second type is a special screen.

The normal display screen is the screen output by the display 602 in general daily use scenarios, which meets the needs of the user for the display 602 in daily use scenarios. For example, when the user browses the web, processes documents, watches movies, etc., the load on the display circuit 604 for this type of display screen is relatively low.

The special screen refers to a high-contrast screen, a rapidly changing scene, a high-resolution movie, etc., or a screen with a heavy load on the display circuit 604. The special screen also includes the test screen generated during the performance test of the display module 600. Specifically, during the performance test of the display module 600, the stability of the display circuit 604 needs to be checked to ensure that the display screen output by the display 602 meets the user's expectations. Therefore, during the performance test phase of the display module 600, the display module 600 will be made to output, for example, a flicker test screen, a dynamic test screen, etc., so as to simulate the performance of the display module 600 under some high-load scenarios.

In some embodiments, the driving circuit 620 in the drive module 606 includes an array of driving parameter sets, such as a first parameter set and a second parameter set. Each driving parameter set may include different driving parameters, such as charging time, charging speed, display time, pixel inversion method, page update frequency, gate voltage, pixel voltage, or other display parameters. Each driving parameter set may correspond to each type of display screen, for example, there is a first parameter set corresponding to the first type and a second parameter set corresponding to the second type.

The driving circuit 620 can drive the display circuit 604 through the driving parameter set to adjust the display effect shown on the display 602, thereby optimizing the quality of the picture shown on the display 602 to meet the visual needs of users. As mentioned above, when the types of display screens are different, the load borne by the display circuit 604 may be different. At this time, if the same driving parameter set is used to adjust the display screen, the quality of the display screen presented on the display 602 may be poor when the display module 600 displays individual types of display screens.

For example, in an embodiment where the first type is a normal display screen and the second type is a special screen, if the driving parameter set in the driving circuit 620 only has the first parameter set corresponding to the normal display screen, when the display module 600 wants to output a special screen, unexpected bad effects such as horizontal stripes, vertical stripes, and squares will appear on the display 602. And if the driving parameter set in the driving circuit 620 only has the second parameter set corresponding to the special screen, when the display module 600 wants to output back to the normal display screen, the display screen on the display 602 may have uneven brightness, color distortion, or fail the reliability test during the reliability test of the display module 600.

Therefore, when the driving parameters in each driving parameter set of the display circuit 604 respectively correspond to the types of each display screen, the driving circuit 620 can apply different driving parameter sets for different screen types, thereby ensuring that the display 602 can provide a stable and high-quality display effect under different screen types.

When the display circuit 604 controls the display 602 to output a display screen, the computing module 610 can obtain the characteristic signal of the display screen through the display circuit 604, and analyze this characteristic signal to determine the type of the display screen.

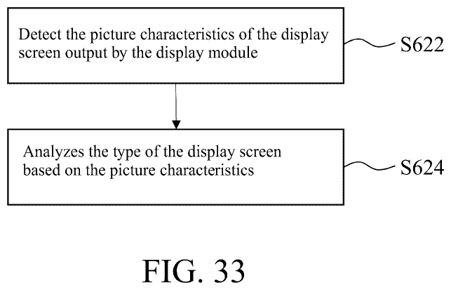

Please refer to FIG. 33. FIG. 33 is a flowchart of detecting the type of a display screen according to some embodiments of the present disclosure. In some embodiments, when the computing module 610 detects the type of the display screen, it detects the picture characteristics of the display screen output by the display module 600 (step S622), and analyzes the type of the display screen based on the picture characteristics (step S624).

In some embodiments, the screen feature is the touch feature value. When the display circuit 604 controls the display 602 to output a special screen of the second type (for example, the aforementioned heavy-load screen or test screen), the display circuit 604 may generate a strong electromagnetic field, resulting in changes in the touch feature value, such as noise, capacitance value changes, and changes in the noise signal ratio. By monitoring the changes in the touch feature value through the computing module 610, it can be inferred whether the display screen currently output by the display 602 belongs to a special screen. In addition, in some other embodiments, the screen feature is screen data, including brightness information, contrast, color composition information, dynamic features, etc. After the computing module 610 obtains the screen data, it makes a type judgment, and then determines the type of the display screen that the display circuit 604 controls the display 602 to display. Among them, the brightness information includes the distribution of high-brightness or low-brightness areas in the display screen, the contrast includes whether there is a high-contrast scene, the color composition information includes whether the color composition in the display screen contains a large number of monochromatic areas or high-saturation areas, and the dynamic features include the speed of the display screen change, such as whether there are fast-moving objects or frequently changing images.

Once the computing module 610 calculates the type of the display screen, it will generate a type signal and transmit it to the driving circuit 620. Then, the driving circuit 620 selects the corresponding driving parameter group from multiple driving parameter groups according to the type signal, so as to optimize the display screen output by the display circuit 604 according to the selected driving parameter group, so as to reduce interference and improve the image quality.

In some embodiments, the computing module 610 continuously receives the screen features generated by the display circuit 604, and transmits the type signal to the driving circuit 620 after judging the type of the display screen. When the type signal received by the driving circuit 620 changes, for example, the type signal received by the driving circuit 620 changes from the signal of the first type to the signal of the second type, the driving circuit 620 will immediately change from selecting the first parameter group to selecting the second parameter group, and optimize the display screen output by the display circuit 604 with the second parameter group instead.

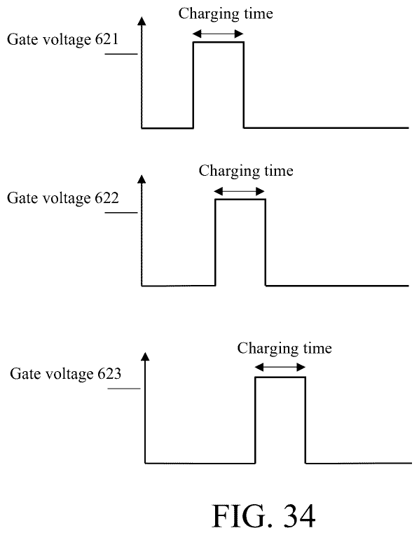

As mentioned above, the driving parameters in different driving parameter sets are different. Please refer to FIG. 34. FIG. 34 is a schematic diagram of the waveform of the gate voltage signal according to some embodiments of the present disclosure. For example, the gate voltage and charging time between each driving parameter set may vary. The gate voltages 621, 622, and 623 respectively control the pixels in different rows on the display 602, so that the display circuit 604 sequentially receives the image signals from the input source. When the driving circuit 620 changes from selecting the first parameter set to selecting the second parameter set according to the type of the display screen, the charging time of the gate voltages 621, 622, and 623 can be changed, that is, the time when the signal changes of each gate voltage 621, 622, and 623 occur is changed. Thus, when different types of display screens are displayed on the display 602, the capacitive coupling effect generated during the operation of the display 602 can be reduced, the unnecessary voltage changes or interferences in the display circuit 604 can be reduced, and the occurrence of uneven brightness, flickering or other display abnormalities of the display screen can be avoided.

In some embodiments, the touch time and display time between each driving parameter set may vary. For example, in the embodiment where the first type is a normal display screen and the second type is a special screen, if the display screen switches from the normal display screen to the special screen, at this time, the computing module 610 obtains the type of the display screen by detecting the screen features and outputs the type signal to the driving circuit 620. After receiving the type signal, the driving circuit 620 changes from selecting the first parameter set to selecting the second parameter set, so that the touch time of the display 602 is shortened and the display time is lengthened, thereby providing a better display effect for the user.

When the display screen switches back from the special screen to the normal display screen, the type signal received by the driving circuit 620 will change from the second type to the first type. Immediately afterwards, the driving circuit 620 changes back from selecting the second parameter set to selecting the first parameter set, so that the touch time of the display 602 is lengthened and the display time is shortened compared with when the driving circuit 620 selects the second parameter set.

In some embodiments, the pixel inversion methods between each driving parameter set are different. For example, when the type of the display screen is the first type, such as a normal display screen, the pixel inversion method of the first parameter set corresponding to the first type is column inversion (Column Inversion). When the type of the display screen is the second type, such as a heavy-loaded special screen, the pixel inversion method of the second parameter set corresponding to the second type is two-line inversion (2 Line Inversion).

In some embodiments, when the pixel inversion method changes based on the driving parameter set selected by the driving circuit 620, for example, when changing from column inversion to two-line inversion, the flickering and texture in the horizontal direction of the display screen can be reduced. However, in some cases, pixel inversion may cause the overall brightness of the display screen to decrease. At this time, the computing module 610 can obtain the screen features and perform calculations, and generate a compensation signal to adjust the voltage or other parameters in the driving parameter set corresponding to the current screen type, thereby compensating for the brightness of the display screen.

In some embodiments, the screen inversion modes in the driving parameter group can also correspond to different types of display screens, such as 2 Dot Inversion, 1+2 Dot Inversion, 4 Dot Inversion, 4 Line Inversion, etc., which are not limited here.

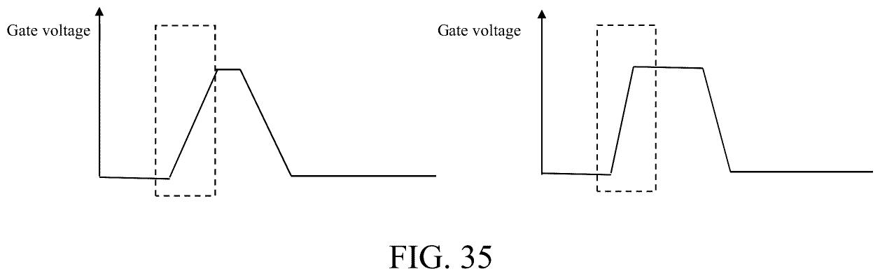

Please refer to FIG. 35. FIG. 35 is a schematic waveform diagram of the charging speed according to some embodiments of the present disclosure. In some embodiments, the charging speeds between each driving parameter group are different. For example, when the type of the display screen is the first type, such as a normal display screen, the charging speed of the driving display circuit 604 in the first parameter group corresponding to the first type is relatively fast. When the type of the display screen is the second type, such as a heavy-load screen of a special screen, the charging speed in the second parameter group corresponding to the second type is relatively slow. The voltage waveform of the gate voltage is shown in FIG. 35. It can be seen that under the same charging time (marked by the dotted frame), the charging speed in the driving parameter group can be adjusted and then applied to different types of display screens to achieve the effect of optimizing the display screen.

In some embodiments, the adjustable parameters in the driving parameter group can be any combination of the above-listed items, and can also include any other unlisted parameters that can adjust the effect of the screen displayed by the display module 600.

Please refer to FIG. 31 again. In some embodiments, the driving parameter sets in the driving circuit 620 can be adjusted and added at any time. The driving parameter sets can be multiple sets of parameters pre-adjusted for various types of display screens, and are stored in the driving circuit 620 when the driving circuit 620 is set. When the computing module 610 detects the type of the display screen, the driving circuit 620 can switch among the multiple sets of driving parameters by itself.

In other embodiments, multiple sets of driving parameter sets can be stored in the external memory 630. After the external memory 630 is connected to the driving circuit 620, the driving parameter sets are stored in the driving circuit 620.

In some embodiments, although the above examples take the ordinary display screen as the first type of display screen and the special screen as the second type, it is not limited to this.

Referring back to FIG. 1 and FIG. 2, in some embodiments, the liquid crystal display device (LCD device) 1 includes a backlight module 10, a quantum dot repairing film 11, a quantum dot layer 12, and a panel module 13. In some embodiments, when the backlight module 10 is in use, when the screen displayed by the display device contains graphics or text with edges, the light-emitting diode (LED) panel included in the backlight module 10 may cause additional LEDs to emit light, resulting in a halo (corresponding to the additionally-emitting LEDs) on the screen displayed by the display device, which further affects the quality of the display device. In view of this, the following embodiments further describe various LED arrays and LED panels. In some embodiments, the LED arrays and LED panels in the following embodiments can be used to implement or be applied to the backlight module 10. However, the present disclosure is not limited to this. Under different design considerations or application scenarios, other structures, processes, or manufacturing processes can be adopted to implement the backlight module 10 disclosed in the present disclosure.

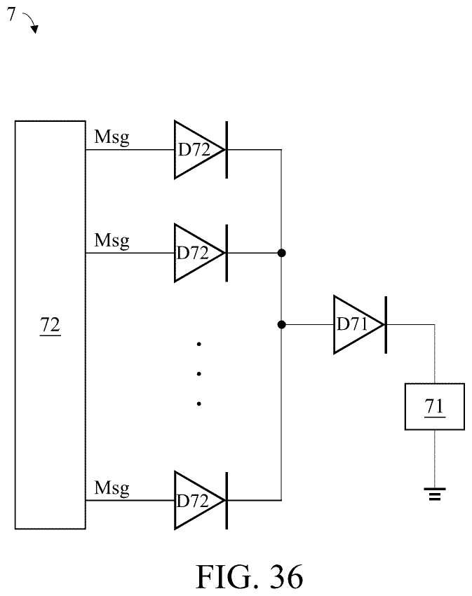

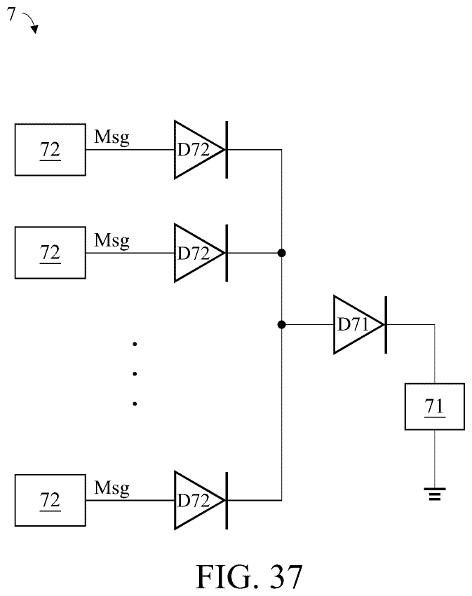

Please refer to FIG. 36 and FIG. 37. FIG. 36 is a circuit schematic diagram of an LED array according to an embodiment of the present disclosure, and FIG. 37 is a circuit schematic diagram of an LED array according to another embodiment of the present disclosure. An LED array 7 includes an LED D71 (hereinafter referred to as the first LED D71) and a plurality of other LEDs D72 (hereinafter referred to as the second LEDs D72), and the plurality of second LEDs D72 are connected in parallel to the first LED D71. In other words, in some embodiments, the output terminals of each second LED D72 are coupled to the input terminal of the first LED D71 and the output terminals of the remaining second LEDs D72.

In some embodiments, in response to the first LED D71 being grounded and one of the second LEDs D72 receiving a modulation signal Msg, the first LED D71 and the second LED D72 that receives the modulation signal Msg emit light. Here, at any time point during the operation of the LED array 7, one of the plurality of second LEDs D72 and the first LED D71 will emit light simultaneously. In other words, in some embodiments, the plurality of second LEDs D72 will not receive the modulation signal Msg simultaneously, and the first LED D71 will only receive one modulation signal Msg from one of the second LEDs D72 at any time point during the operation of the LED array 7.

As shown in FIG. 36, in some embodiments, the LED array 7 further includes a control element 71 and a modulation signal generation element 72. The control element 71 is electrically connected to the first LED D71, and the modulation signal generation element 72 is electrically connected to the plurality of second LEDs D72. As shown in FIG. 37, in other embodiments, the LED array 7 further includes a control element 71 and a plurality of modulation signal generation elements 72. The control element 71 is electrically connected to the first LED D71, and each modulation signal generation element 72 is electrically connected to each second LED D72.

In some embodiments, the control element 71 is used to control the first LED D71 to be open-circuited or grounded. In response to the first LED D71 being open-circuited, even if the first LED D71 receives the modulation signal Msg from the second LED D72, no potential difference is generated between the input terminal and the output terminal of the first LED D71, so that the first LED D71 cannot emit light. In response to the first LED D71 being grounded and receiving the modulation signal Msg from the second LED D72, a potential difference is generated between the input terminal and the output terminal of the first LED D71, so that the first LED D71 emits light.

In some embodiments, the modulation signal generation element 72 is used to generate the modulation signal Msg to be provided to each second LED D72. Taking FIG. 36 as an example, in this embodiment, the modulation signal Msg received by each second LED D72 is generated through the same modulation signal generation element 72. Taking FIG. 37 as an example again, in this embodiment, the modulation signal Msg received by each second LED D72 is generated through its corresponding modulation signal generation element 72.

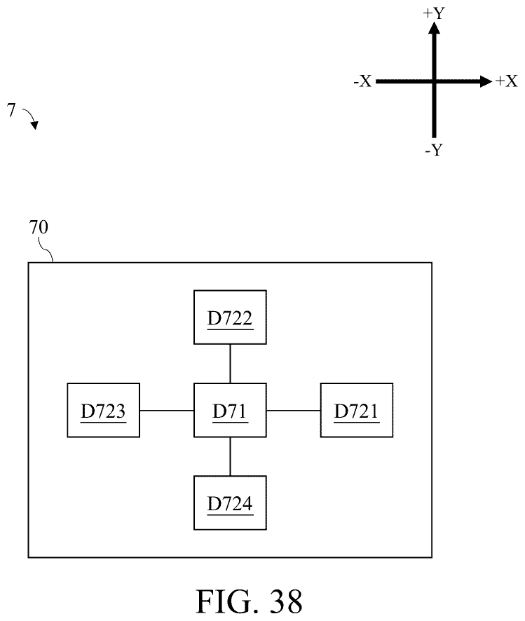

Please refer to FIG. 38. FIG. 38 is a top view schematic diagram of a light emitting diode (LED) array according to an embodiment of the present disclosure. In some embodiments, the LED array 7 further includes a circuit board 70, and the first LED D71 and a plurality of second LEDs D72 are disposed on the circuit board 70. In some embodiments, the plurality of second LEDs D72 are four second LEDs D721, D722, D723, and D724, and the four second LEDs D721, D722, D723, and D724 are respectively adjacent to a first side, a second side, a third side, and a fourth side of the first LED D71.

In some embodiments, the directions from the first side to the fourth side of the first LED D71 correspond to the directions in the Cartesian coordinate system. Taking FIG. 38 as an example, in this embodiment, the direction of the first side of the first LED D71 corresponds to the positive X direction in the Cartesian coordinate system, the direction of the second side of the first LED D71 corresponds to the positive Y direction in the Cartesian coordinate system, the direction of the third side of the first LED D71 corresponds to the negative X direction in the Cartesian coordinate system, and the direction of the fourth side of the first LED D71 corresponds to the negative Y direction in the Cartesian coordinate system. Here, the second LED D721 is adjacent to the first side of the first LED D71, the second LED D722 is adjacent to the second side of the first LED D71, the second LED D723 is adjacent to the third side of the first LED D71, and the second LED D724 is adjacent to the fourth side of the first LED D71.

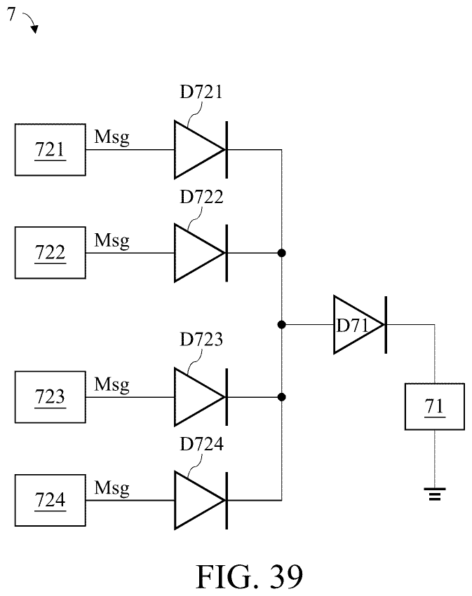

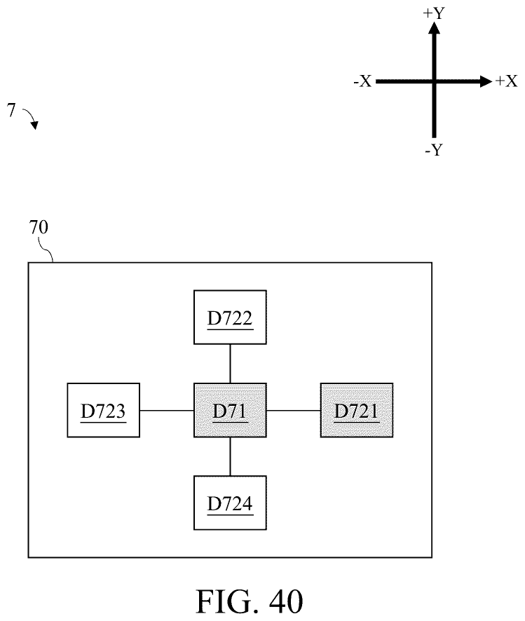

Please further refer to FIG. 39 and FIG. 40. FIG. 39 is a circuit schematic diagram of the LED array in FIG. 38 according to the present disclosure, and FIG. 40 is a top view schematic diagram of an embodiment of the LED array in FIG. 38 according to the present disclosure. The following will take FIG. 39 and FIG. 40 as examples to illustrate the operation mode of the LED array 7. As shown in FIG. 39, assuming that each of the second LEDs D721/D722/D723/D724 in the LED array 7 has a corresponding modulation signal generation element 721/722/723/724, in response to the first LED D71 being grounded and the second LED D721 receiving the modulation signal Msg from the modulation signal generation element 721, the first LED D71 and the second LED D721 emit light simultaneously (as shown in FIG. 40).

Similarly, in response to the first LED D71 being grounded and the second LED D722 receiving the modulation signal (Msg) from the modulation signal generation element 722, the first LED D71 and the second LED D722 emit light simultaneously (not shown in the figure). In response to the first LED D71 being grounded and the second LED D723 receiving the modulation signal (Msg) from the modulation signal generation element 723, the first LED D71 and the second LED D723 emit light simultaneously (not shown in the figure). In response to the first LED D71 being grounded and the second LED D724 receiving the modulation signal (Msg) from the modulation signal generation element 724, the first LED D71 and the second LED D724 emit light simultaneously (not shown in the figure).

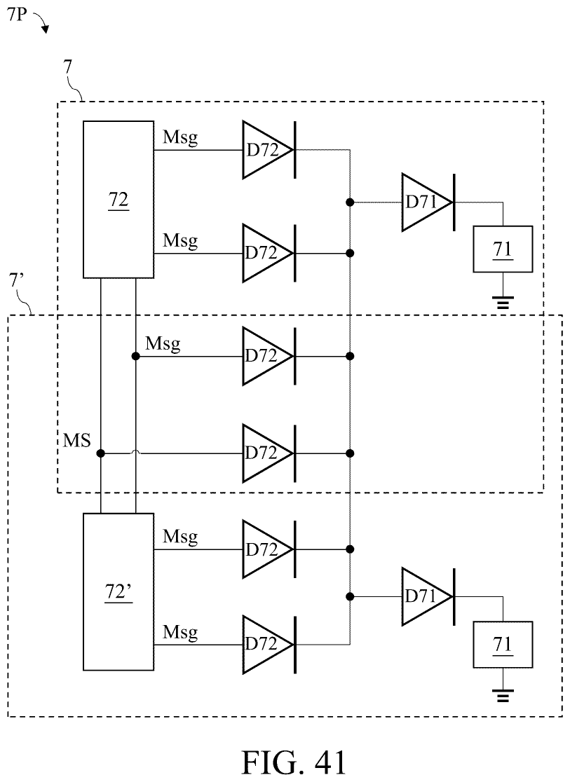

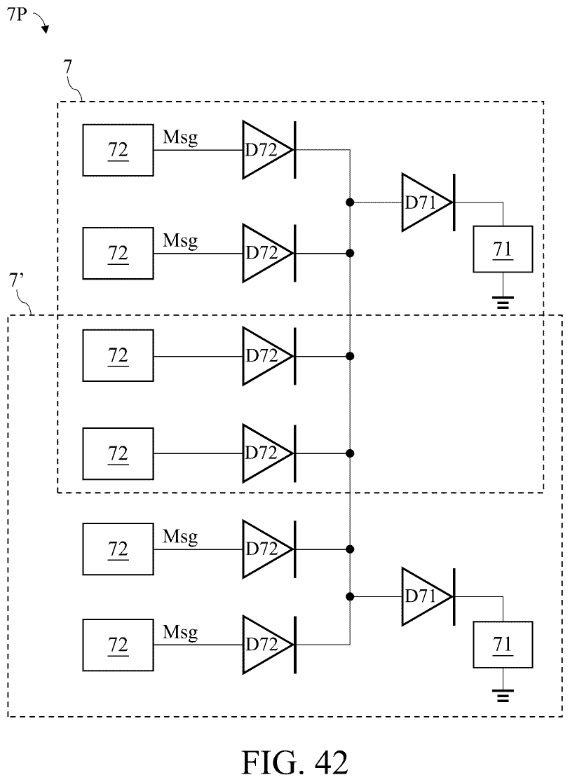

Please refer to FIG. 41 and FIG. 42. FIG. 41 is a schematic circuit diagram of an LED panel according to an embodiment of the present disclosure, and FIG. 42 is a schematic circuit diagram of an LED panel according to another embodiment of the present disclosure. In some embodiments, the LED panel 7P includes a plurality of LED arrays 7 of any of the foregoing embodiments, and at least one of the plurality of second LEDs D72 is shared by two adjacent LED arrays 7. Taking FIG. 41 and FIG. 42 as an example, in this embodiment, the LED panel 7P includes two LED arrays 7 and 7′, and the LED arrays 7 and 7′ share two second LEDs D72.

In some embodiments, the modulation signal (Msg) received by each second LED D72 of each LED array 7 in the LED panel 7P is generated through the same modulation signal generation element 72. Taking FIG. 41 as an example, in this embodiment, each LED array 7/7′ in the LED panel 7P corresponds to the LED array 7 shown in FIG. 36. Here, the modulation signal (Msg) received by each second LED D72 in the LED array 7 is generated through the modulation signal generation element 72, and the modulation signal (Msg) received by each second LED D72 in the LED array 7′ is generated through the modulation signal generation element 72′. In other words, in some embodiments, the modulation signal (Msg) received by the two second LEDs D72 shared by the LED arrays 7 and 7′ can come from one of the modulation signal generation elements 72 and 72′.

In other embodiments, the modulation signals Msg received by each second LED D72 are generated through their respective corresponding modulation signal generation elements 72. Taking FIG. 42 as an example, in this embodiment, each LED array 7/7′ in the LED panel 7P corresponds to the LED array 7 shown in FIG. 37. Here, the modulation signals Msg received by each second LED D72 are generated through their respective corresponding modulation signal generation elements 72. In other words, in some embodiments, the LED arrays 7 and 7′ not only share two second LEDs D72, but also share the corresponding two modulation signal generation elements 72.

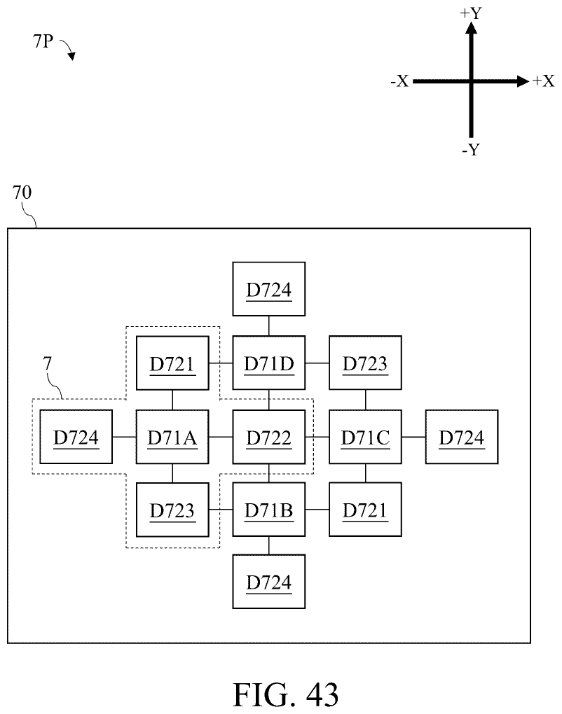

Please refer to FIG. 43. FIG. 43 is a top view schematic diagram of an LED panel according to an embodiment of the present disclosure. In some embodiments, the LED panel 7P further includes a circuit board 70, and the first LED D71 and a plurality of second LEDs D72 in each LED array 7 are disposed on the circuit board 70. Taking FIG. 43 as an example, in this embodiment, the LED panel 7P includes four LED arrays 7. Each LED array 7 includes a first LED D71A/D71B/D71C/D71D, and the plurality of second LEDs D72 in each LED array 7 are four second LEDs D721, D722, D723, and D724.

In some embodiments, each of the second LEDs D721, D722, D723, and D724 in each LED array 7 is individually adjacent to a first side, a second side, a third side, and a fourth side of the first LED D71A/D71B/D71C/D71D in each LED array 7. In addition, in some embodiments, the directions from the first side to the fourth side of each first LED D71A/D71B/D71C/D71D correspond to the directions in the Cartesian coordinate system. Taking FIG. 43 as an example, in this embodiment, the direction of the first side of the first LED D71 corresponds to the positive X direction in the Cartesian coordinate system, the direction of the second side of the first LED D71 corresponds to the positive Y direction in the Cartesian coordinate system, the direction of the third side of the first LED D71 corresponds to the negative X direction in the Cartesian coordinate system, and the direction of the fourth side of the first LED D71 corresponds to the negative Y direction in the Cartesian coordinate system.

Taking the LED array 7 surrounded by the dotted line in FIG. 43 as an example, it includes a first LED D71A and four second LEDs D721, D722, D723, and D724. Among them, the second LED D721 is adjacent to the second side (corresponding to the positive Y direction) of the first LED D71A, the second LED D722 is adjacent to the first side (corresponding to the positive X direction) of the first LED D71A, the second LED D723 is adjacent to the fourth side (corresponding to the negative Y direction) of the first LED D71A, and the second LED D724 is adjacent to the third side (corresponding to the negative X direction) of the first LED D71A.

In some embodiments, since at least one of the plurality of second LEDs D72 is shared by two adjacent LED arrays 7 in the LED panel 7P, each second LED D72 in the LED array 7 can be shared by more than two LED arrays 7 at the same time. Taking FIG. 43 as an example, in this embodiment, the LED array 7 including the first LED D71A and the LED array 7 including the first LED D71D share the second LED D721. In addition, all the LED arrays 7 shown in FIG. 43 share the second LED D722.

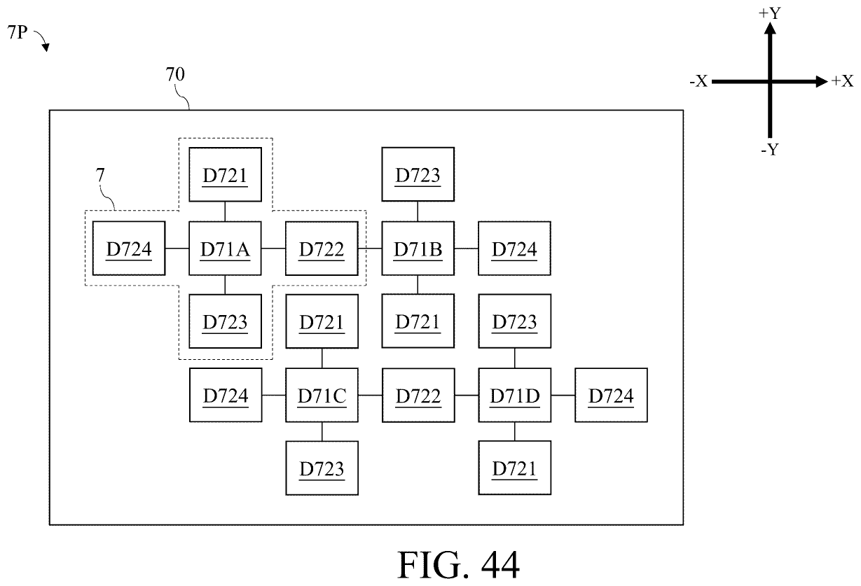

Please further refer to FIG. 44, which is a top view schematic diagram of an LED panel according to another embodiment of the present disclosure. In some embodiments, two adjacent LED arrays 7 in the LED panel 7P share only one second LED D72. Taking FIG. 44 as an example, in this embodiment, the LED array 7 including the first LED D71A and the LED array 7 including the first LED D71B share only one second LED D722, and the LED array 7 including the first LED D71C and the LED array 7 including the first LED D71D also share only one second LED D722.

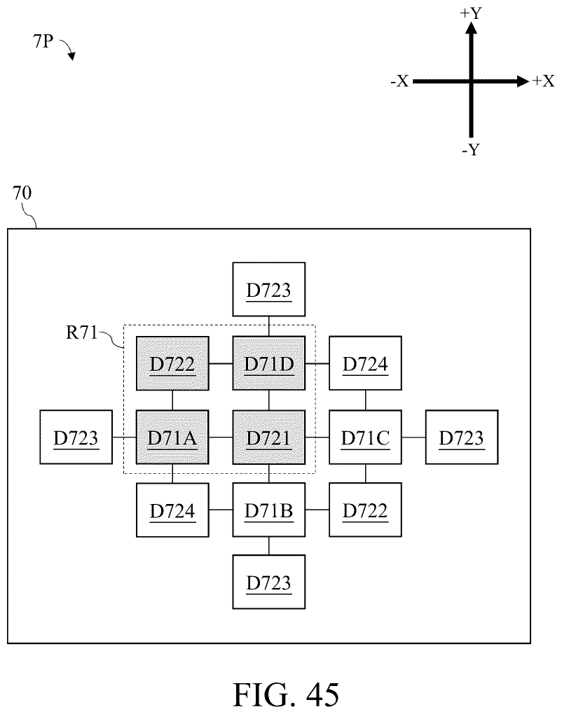

Please refer to FIGS. 43 and 45. FIG. 45 is a top-view schematic diagram of an embodiment of the LED panel in FIG. 43 according to the present disclosure. The following will take FIG. 45 as an example to illustrate the operation mode of the LED panel 7P. In some embodiments, when the LED panel 7P is operating, the LED panel 7P can control the first LEDs D71A/D71B/D71C/D71D and one of the second LEDs D721/D722/D723/D724 in each LED array 7 to emit light. For example, assume that the LED panel 7P is applied to a display device, and when the range of the display device corresponding to the dashed bounding box R71 in FIG. 45 is to display an image, the LED panel 7P can first control the first LED D71A and the second LEDs D721/D722 to emit light simultaneously (step S70), and then control the first LED D71D and the second LEDs D722/D721 to emit light simultaneously (step S71). In response to the LED panel 7P repeatedly performing step S70 and step S71 within a cycle (corresponding to the refresh frequency when the display device displays an image), the first LEDs D71A, D71D and the second LEDs D721, D722 shared by them visually emit light simultaneously. Here, the LED panel 7P can control the minimum number (in this embodiment, the minimum number is 4) of light emitting diodes to emit light to display the image in the display device, thereby avoiding the problem of halos on the image displayed by the display device.

In some embodiments, the first LED D71 and the second LED D72 can be monochromatic light emitting diodes, multicolor light emitting diodes, organic light emitting diodes (Organic LED, OLED), quantum-dot light emitting diodes (Quantum-dot LED, QLED), mini light emitting diodes (Mini LED), or micro light emitting diodes (Micro LED), but are not limited thereto.

In some embodiments, the control element 71 can be a hardware element with a control function or a semiconductor element used as a switch, such as but not limited to a central processing unit (CPU), a system-on-chip (SoC), a microprocessor, a digital signal processor (DSP), a complex programmable logic device (CPLD), a field programmable gate array (FPGA), an application specific integrated circuit (ASIC), a microcontroller unit (MCU), a bipolar junction transistor (BJT), an insulated gate bipolar transistor (IGBT), and a metal-oxide-semiconductor field-effect transistor (MOSFET).

In some embodiments, the modulation signal Msg can be a digital signal or an analog signal. Additionally, in some embodiments, the modulation signal Msg can be a pulse width modulation (PWM) signal. Here, the modulation signal generation element 72 is a pulse width modulation signal generator. In other embodiments, the modulation signal Msg can be a pulse amplitude modulation (PAM) signal. Here, the modulation signal generation element 72 is a pulse amplitude modulation signal generator.

In some embodiments, the circuit board 70 can be a single-layer printed circuit board (PCB), a double-layer PCB, or a multi-layer PCB, but is not limited thereto.

In summary, the liquid crystal display device proposed according to some embodiments of the present disclosure includes a quantum dot repairing film. When the quantum dot material at the edge of the quantum dot layer in the liquid crystal display device fails due to the influence of moisture in the air, the quantum dot material in the quantum dot repairing film can replace the failed quantum dot material to produce light with normal color. Additionally, since the quantum dot repairing film has ductility, even if there are gaps when the quantum dot layer is disposed on the backlight module and covers the quantum dot repairing film, the quantum dot repairing film can fill these gaps to prevent moisture in the air from entering the quantum dot layer.

Additionally, the light emitting diode circuit and its circuit board structure proposed according to some embodiments of the present disclosure can use a resistor as a jumper for any section of each conductive trace on the circuit board to avoid short-circuits caused by the intersection of conductive traces, thereby simplifying the complexity of the circuit design. Moreover, even if two sections of the same conductive trace intersect and cause a short-circuit, the light emitting diode circuit and its circuit board structure can also use a resistor as a jumper for either of these two sections. Furthermore, the resistor can also be used to adjust the resistance value of the circuit formed by each conductive trace to ensure that the light-emitting effects of each light-emitting unit on the light emitting diode circuit are consistent and uniform.

Additionally, in the light emitting diode backlight panel proposed according to some embodiments of the present disclosure, in the same scanning sequence, the light emission points in the same arrangement order of adjacent drive lines (such as the first light emission point P31, the second light emission point P32, the third light emission point P33, and the fourth light emission point P34 in the first row in FIG. 18) will not receive the scan signal simultaneously to suppress the resonance noise generated by the power supply circuit.

In addition, according to some embodiments of the present disclosure, the TFT-LCD panel unit and a manufacturing method thereof set metal posts between the thin-film transistor substrate and the color filter substrate in the TFT-LCD panel unit, so that the thin-film transistor substrate is electrically connected to the color filter substrate. In addition, the TFT-LCD panel unit and a manufacturing method thereof can form the metal posts after forming the gate layer/source layer/drain layer in the thin-film transistor substrate without changing the instruments and materials of the process, so as to save the time and cost of changing instruments and materials in the process of the TFT-LCD panel.

In addition, according to some embodiments of the present disclosure, the panel cutting method can cut the second excess material 524 of the second substrate 520 to generate stress applied to the first cutting line L51 of the first substrate 510, so that the first cutting line L51 breaks naturally, and avoid the generation of feather cracks 540 in the terminal area 516, thereby improving the quality and reliability of the first sub-substrate 512.

In addition, according to some embodiments of the present disclosure, the image processing method enables the image processing panel to optimize the picture with the corresponding driving parameter set when the display module 600 displays different kinds of pictures, and then provides users with a good visual effect when displaying special pictures (such as heavy-load pictures or special test pictures).

In addition, when the LED array and the LED panel proposed according to some embodiments of the present disclosure are applied to a display device, the LED array and the LED panel can reduce the number of light emitting diodes (including the first light emitting diode and the second light emitting diode) required for the display device to display pictures, so as to avoid the problem of halos on the pictures displayed by the display device. In addition, even if the picture displayed by the display device includes a picture with graphics or text having edges, the LED panel can control one of the plurality of second light emitting diodes in each LED array that is most suitable for displaying this graphic or text to emit light, thereby reducing the halos generated when the display device displays this graphic or text.

Although the present disclosure has been clearly disclosed according to the above different embodiments, each embodiment is not intended to limit the present disclosure. Any person with ordinary knowledge in the technical field can make various modifications, substitutions or omissions to the above embodiments without departing from the spirit and scope of the present disclosure, which still belong to the technical scope protected by the present disclosure. Therefore, the protection scope of the present disclosure shall be subject to the scope defined by the patent application.

TABLE 1

| | | |
|---|---|---|
| | The depth of feather | The depth of feather |
| | cracks in the | cracks in the |
| Number of | terminal area ≤50 μm | terminal area >50 μm |

| first sub- | Number | | Number | |
|---|---|---|---|---|
| substrates | of pieces | Proportion | of pieces | Proportion |
| 2712 | 619 | 22.82% | 76 | 2.79% |

TABLE 2

| | The depth of feather | | The depth of feather | |
|---|---|---|---|---|
| | cracks in the | | cracks in the | |
| Number of | terminal area ≤50 μm | | terminal area >50 μm | |
| first sub- | Number | | Number | |
| substrates | of pieces | Proportion | of pieces | Proportion |
| 1000 | 23 (Maximum | 2.3% | 0 | 0% |
| | crack 12 μm) | | | |

What is claimed is:

1. A liquid crystal display device, comprising:
a backlight module having a light-emitting surface, the light-emitting surface having a central area and a peripheral area surrounding the central area;
a quantum dot repairing film disposed on the peripheral area;
a quantum dot layer disposed on the central area and the quantum dot repairing film; and
a panel module disposed on the quantum dot layer, the panel module comprising a light-shielding layer, wherein a projection of the light-shielding layer along a normal of the light-emitting surface partially overlaps a projection of the quantum dot repairing film along the normal of the light-emitting surface, and a projection of an inner edge of the light-shielding layer along the normal of the light-emitting surface is located in the projection of the quantum dot repairing film along the normal of the light-emitting surface.

2. The liquid crystal display device according to claim 1, wherein the backlight module comprises:
a substrate layer, comprising a plurality of sidewalls and a base plate, wherein the plurality of sidewalls are disposed around the base plate;
a reflective layer disposed on the base plate;
a light guide layer disposed on the reflective layer; and
an edge-lit backlight unit disposed on a wall surface of at least one of the plurality of sidewalls.

3. The liquid crystal display device according to claim 2, wherein the quantum dot repairing film is further disposed on a wall surface of each of the remaining sidewalls.

4. The liquid crystal display device according to claim 1, wherein the backlight module comprises:
a substrate layer, comprising a plurality of sidewalls and a base plate, wherein the plurality of sidewalls are disposed around the base plate;
a reflective layer disposed on the base plate;
a light guide layer disposed on the reflective layer; and
a direct-lit backlight unit disposed between the reflective layer and the light guide layer.

5. The liquid crystal display device according to claim 4, wherein the quantum dot repairing film is further disposed on a wall surface of each of the sidewalls.

6. The liquid crystal display device according to claim 1, wherein the backlight module comprises:
a circuit board, comprising a first surface;
a plurality of first light-emitting units disposed on the first surface;
a first terminal set disposed on the first surface;
a first conductive trace disposed on the first surface for electrically connecting the plurality of first light-emitting units and the first terminal set together;
a plurality of second light-emitting units disposed on the first surface;
a second terminal set disposed on the first surface;
a second conductive trace disposed on the first surface for electrically connecting the plurality of second light-emitting units and the second terminal set together; and
at least one resistor disposed on the first conductive trace and/or the second conductive trace for serving as a jumper for any section of the first conductive trace and/or a jumper for any section of the second conductive trace.

7. The liquid crystal display device according to claim 1, wherein the backlight module comprises:
a circuit board, comprising a first surface;
a plurality of electronic components disposed on the first surface;
a plurality of conductive traces disposed on the first surface, wherein each of the conductive traces is configured for electrically connecting at least two of the plurality of electronic components together; and
at least one resistor disposed on at least one of the plurality of conductive traces for serving as a jumper for any section of at least one of the plurality of conductive traces.

8. The liquid crystal display device according to claim 1, wherein the backlight module comprises:
a circuit board having an operable area;
a plurality of drive lines, located on the circuit board and sequentially arranged on the operable area in a first arrangement direction; and
a plurality of scan lines located on the circuit board, defining a plurality of light emission points in a matrix configuration with the drive lines on the operable area, wherein the relative positions of the plurality of light emission points formed by a same scan line and the drive lines among the light emission points are staggered from each other in a second arrangement direction, and the first arrangement direction is different from the second arrangement direction.

9. The liquid crystal display device according to claim 8, wherein the drive lines comprise a first drive line, a second drive line, a third drive line, and a fourth drive line, and the scan lines comprise a first scan line, a second scan line, a third scan line, and a fourth scan line.

10. The liquid crystal display device according to claim 9, wherein
the light emission points are divided into a plurality of first light emission points, a plurality of second light emission points, a plurality of third light emission points, and a plurality of fourth light emission points according to a scanning order;
the intersections of the first scan line with the first drive line, the second drive line, the third drive line, and the fourth drive line are the first light emission points;
the intersections of the second scan line with the first drive line, the second drive line, the third drive line, and the fourth drive line are the second light emission points;
the intersections of the third scan line with the first drive line, the second drive line, the third drive line, and the fourth drive line are the third light emission points; and
the intersections of the fourth scan line with the first drive line, the second drive line, the third drive line, and the fourth drive line are the fourth light emission points.

11. The liquid crystal display device according to claim 1, wherein the panel module comprises:
a first polarization layer;
a thin film transistor layer disposed on the first polarization layer;
a color filter layer disposed on the thin film transistor layer; and
a second polarization layer disposed on the color filter layer;
wherein, a sum of a thickness of the first polarization layer, a thickness of the thin film transistor layer, a thickness of the color filter layer, and a thickness of the second polarization layer is equal to a thickness of the light-shielding layer, and the light-shielding layer surrounds the first polarization layer, the thin film transistor layer, the color filter layer, and the second polarization layer.

12. The liquid crystal display device according to claim 1, wherein the panel module comprises:
a thin film transistor substrate, comprising a plurality of electrode layers;
a liquid crystal layer disposed on a surface of the thin film transistor substrate;
a metal post extending from one of the plurality of electrode layers along a normal direction of the surface of the thin film transistor substrate to be exposed on the surface of the thin film transistor substrate, wherein the metal post is adjacent to the liquid crystal layer; and
a color filter substrate disposed on the liquid crystal layer and the metal post and electrically connected to the thin film transistor substrate through the metal post;
wherein, a material of the metal post is the same as that of one of the plurality of electrode layers.

13. The liquid crystal display device according to claim 12, wherein the plurality of electrode layers comprise a gate layer, a drain layer and a source layer, and the thin film transistor substrate further comprises:
a glass layer, wherein the gate layer is disposed on the glass layer;
a first insulating layer disposed on the glass layer to cover the gate layer;
a channel layer disposed on the first insulating layer, wherein the drain layer and the source layer are respectively disposed on two sides of the channel layer and are spaced apart by an interval; and
a second insulating layer disposed on the drain layer, the source layer and the channel layer in the interval.

14. The liquid crystal display device according to claim 12, wherein the metal post is a cylinder, a bottom surface of the metal post is coupled to a surface of one of the plurality of electrode layers, and a top surface of the metal post is coupled to the color filter substrate.

15. The liquid crystal display device according to claim 14, wherein the metal post further comprises at least one metal truncated cone, a bottom surface of the at least one metal truncated cone is coupled to the top surface of the metal post, and a top surface of the at least one metal truncated cone is coupled to the color filter substrate.

16. The liquid crystal display device according to claim 12, wherein the metal post is a truncated cone, a bottom surface of the metal post is coupled to a surface of one of the plurality of electrode layers, and a top surface of the metal post is coupled to the color filter substrate.

17. A manufacturing method of a liquid crystal display device, comprising the following steps:
providing a backlight module, wherein the backlight module has a light-emitting surface, and the light-emitting surface has a central area and a peripheral area surrounding the central area;
disposing a quantum dot repairing film on the peripheral area;
disposing a quantum dot layer on the central area and the quantum dot repairing film;
disposing a panel module on the quantum dot layer; and
disposing a light-shielding layer on the panel module, wherein a projection of the light-shielding layer along a normal of the light-emitting surface partially overlaps a projection of the quantum dot repairing film along the normal of the light-emitting surface, and a projection of an inner edge of the light-shielding layer along the normal of the light-emitting surface is located in the projection of the quantum dot repairing film along the normal of the light-emitting surface.

18. A manufacturing method of a liquid crystal display device, comprising the following steps:
providing a backlight module, wherein the backlight module has a light-emitting surface, and the light-emitting surface has a central area and a peripheral area surrounding the central area;
disposing a quantum dot repairing film on the peripheral area;
disposing a quantum dot layer on the central area and the quantum dot repairing film;
forming a thin-film transistor substrate, wherein the thin-film transistor substrate comprises a plurality of electrode layers;
forming a metal post, wherein the metal post extends from one of the plurality of electrode layers along a normal direction of a surface of the thin-film transistor substrate to be exposed on the surface of the thin-film transistor substrate, and a material of the metal post is the same as that of one of the plurality of electrode layers;
disposing a liquid crystal material on the thin-film transistor substrate to form a liquid crystal layer, wherein the liquid crystal layer is adjacent to the metal post;
disposing a color filter substrate on the liquid crystal layer and the metal post, wherein the color filter substrate is electrically connected to the thin-film transistor substrate through the metal post to form a panel module;
disposing the panel module on the quantum dot layer; and
disposing a light-shielding layer on the panel module, wherein a projection of the light-shielding layer along a normal of the light-emitting surface partially overlaps a projection of the quantum dot repairing film along the normal of the light-emitting surface, and a projection of an inner edge of the light-shielding layer along the normal of the light-emitting surface is located in the projection of the quantum dot repairing film along the normal of the light-emitting surface.

19. The manufacturing method according to claim 18, wherein the plurality of electrode layers comprise a gate layer, a drain layer, and a source layer, and the step of forming the thin-film transistor substrate comprises:
forming the gate layer on a glass layer;
forming a first insulating layer on the glass layer to cover the gate layer;
forming a channel layer on the first insulating layer;
forming the drain layer and the source layer on two sides of the channel layer respectively, wherein there is an interval between the drain layer and the source layer; and
forming a second insulating layer on the source layer, the drain layer, and the channel layer in the interval;
wherein, the step of forming the metal post is synchronized with the step of forming the gate layer, the drain layer, or the source layer.

20. The manufacturing method according to claim 19, wherein the metal post is a cylinder or a truncated cone, a bottom surface of the metal post is coupled to a surface of one of the plurality of electrode layers, and a top surface of the metal post is coupled to the color filter substrate.
